(19) United States
(12) Patent Application Publication
(10) Pub. No.: US 2020/0032062 A1
(43) Pub. Date: Jan. 30, 2020

(54) POLYMER COMPOSITIONS FOR 3-D PRINTING AND 3-D PRINTERS

(71) Applicant: Cornell University, Ithaca, NY (US)

(72) Inventors: Thomas J. WALLIN, Ithaca, NY (US); Robert F. SHEPHERD, Ithaca, NY (US)

(21) Appl. No.: 16/322,424

(22) PCT Filed: Aug. 1, 2017
(86) PCT No.: PCT/US2017/044923

§ 371 Date: Jan. 31, 2019

Related U.S. Application Data
(60) Provisional application No. 62/369,327, filed on Aug. 1, 2016.

(51) Int. Cl. C08L 83/08; B29C 64/129

(52) U.S. Cl. CPC C08L 83/08; B33Y 10/00; B29C 64/129

(57) ABSTRACT

Provided are polymer compositions and methods of making 3D structures. The polymer compositions include a polymer component (e.g., siloxane polymer) having a plurality of vinyl groups and a polymer component (e.g., siloxane polymer) having a plurality of thiol groups. The polymer compositions can be used to form elastomeric 3D structures. Also provided are 3D printers having an exposure window comprising a film of an organic polymer disposed on the outer surface of the exposure window.

### CROSS REFERENCE TO RELATED APPLICATIONS

This application claims priority to U.S. Provisional Application No. 62/369,327, filed on Aug. 1, 2016, the disclosure of which is hereby incorporated by reference.

### STATEMENT REGARDING FEDERALLY SPONSORED RESEARCH

This invention was made with government support under contract no. E55-8204 awarded by the National Aeronautics and Space Administration Jet Propulsion Laboratory. The government has certain rights in the invention.

### FIELD OF THE DISCLOSURE

The disclosure generally relates to polymer-based 3D printing compositions and uses of such compositions. More particularly the disclosure generally relates polysiloxane-based 3D printing compositions with polysiloxanes having thiol and vinyl groups and 3D printing using such compositions.

### BACKGROUND OF THE DISCLOSURE

Advances in material science and manufacturing technologies permit the fabrication of machines comprised entirely of soft components. Such devices deform continuously about their surface, respond to external loads via mechanical compliance, and can perform complex functions in uncontrolled environments. All of these advantages stem from the use of resilient, highly extensible materials with low elastic moduli (E˜1 kPa-10 MPa) similar to biological tissues. These new capabilities can be readily applied to many fields including robotics, stretchable electronics and biomedicine. Soft machines, however, are highly constrained in their construction due to the current practical limitations of lithography and molding processes.

Shaping polymers from rigid molds is the most common method for manufacturing elastomeric devices because it is easy and compatible with a wide variety of chemistries; this strategy, however, is architecturally limited to prismatic structures restricting the design and function of soft machines. Additional labor intensive fabrication steps can combine such molded objects into useful devices, but 3D printing has the potential to simplify and expedite the manufacturing process for hierarchical builds. Direct Ink Writing (DIW) enables the 3D printing of elastomeric chemistries, but the process must choose between high resolution or expedited print times; even with multiple printheads, forming large and complex geometries at high resolution requires long processing times. Further, overhanging designs require sacrificial supports, and more complex architectures are entirely un-printable.

By comparison, stereolithography (SLA) enables rapid (draw rate ˜50 cm·hr⁻¹), direct fabrication of intricate 3D geometries with micron sized resolution. A horizontal shearing force removes the newly formed solid from the substrate window, the part is then translated up one layer height and the low apparent viscosity liquid resin replenishes the build area prior to next light exposure. A common strategy to permit easy delamination is to create a liquid interface between the build window and the cured photopolymer by using a substrate that releases an oxidant, often molecular oxygen, that can stabilize free radicals and obstruct the polymerization reaction. This requirement constrains SLA chemistries to those that undergo free radical chain-growth polymerization (CGP) upon photoirradiation ultimately limiting the set of available SLA materials. Major efforts in this field are directed towards increasing the library of compatible materials.

Stereolithography is an additive manufacturing technique that uses selective photoirradiation to cure a liquid resin of photopolymerizable material. By repeating this process, layer-by-layer, a solid object forms. Compared to other additive manufacturing techniques, stereolithography is attractive because of its rapid build speed, micron resolution, and scalability. The main limitation to stereolithography is the lack of compatible materials, particularly elastomeric materials. The viscosity requirements of the liquid pre-polymer resin during processing limit most current stereolithography resins to those comprised of monomeric and oligomeric acrylates and epoxies. Consequently, these materials are highly crosslinked and glassy at room temperature, therefore exhibiting ultimate strains below 90% and limiting technical applications.

Traditional manufacture of soft elastomeric devices relies on soft lithography, through which only limited architectures can be obtained without labor intensive post processing steps to remove material or combine multiple layers which undermine mechanical integrity. Stereolithography, by comparison, enables the free-form fabrication of three dimensional objects with micron sized features through photopolymerization. Though other iterations exist, many commercially available stereolithography printers employ bottom-up fabrication. Recent advances, such as Continuous Liquid Interface Production (CLIP), enable high throughput, large scale manufacture of compatible materials by reducing build layer heights and removing the need for mechanical delamination of the printed part from the transparent build window.

Polydimethylsilxoane, a class of silicones, is a widely used elastomeric material owing to its excellent mechanical properties, chemical inertness, low toxicity, and resistance to thermal degradation. Most commercial silicones that cure from liquid resins do so by hydrosilylation in the presence of a metal catalyst. Of the hydrosilylation resins that can be photoinitiated, none have been utilized, to date, in stereolithography, and they suffer from long cure times incompatible with rapid prototyping or yield brittle final products. Extrusion based systems like Structur3D and Picsima have recently developed the capabilities to fabricate 3D silicone objects, but these techniques still suffer from low resolution, long build times and other issues inherent to extrusion printing.

Soft machines often necessitate the use of materials with low Young's moduli, high resilience and large ultimate elongations. Although soft robotics promises a new generation of robust, versatile machines capable of complex functions and seamless integration with biology, the fabrication of such soft, three dimensional (3D) hierarchical structures remains a significant challenge. Stereolithography (SLA) is an additive manufacturing technique that can rapidly fabricate the complex device architectures required for the next generation of these systems. Current SLA materials and processes are prohibitively expensive, display little elastic deformation at room temperature, or exhibit Young's moduli exceeding most natural tissues, all which limit use in soft robotics. The SLA processing requirements (i.e., fast, controlled photopolymerization from a low viscosity (vₐₚₚ<5 Pa·s), oxygen-inhibited resin) prevent such soft elastomeric chemistries from being readily accessible for printing. To date, the majority of SLA formulations are concentrated solutions of acrylate monomers and crosslinkers that rapidly reach their gel point upon photoexposure, which is necessary for printing; however, the uncontrolled propagation reaction during CGP leads to further chain-growth, ultimately yielding dense, stiff and brittle networks that display significant shrinkage and incorporate large residual stresses. Only a few works report SLA printed parts with ultimate strains, γᵤₗₜ>100%. One strategy is to print oligomeric acrylate melts that require large photodosages (Hₑ>150 mJ cm⁻²) and custom printers that maintain high resin temperatures to reduce resin viscosity and overcome slow polymerization kinetics. The Carbon™ FPU and EPU materials offer large elongations, but only after a post-processing heat treatment polymerizes a latent polyurethane network. The printer required to use these proprietary materials is also prohibitively expensive for most research groups. The high elastic moduli (E>3 MPa) of these polyurethanes greatly exceeds that of the soft biological systems (i.e., stromal tissue (3 kPa), skeletal muscle (12 kPa) and cartilage (500-900 kPa) that soft robots and biomedical devices seek to replicate. Additionally, the most extensible of these materials possesses poor resilience at room temperature owing to the irreversible deformation of soft-segments along their polymer backbone. Thus, current acrylated-based SLA materials are impractical for soft machines that require high fatigue strength or cyclic loading (e.g., springs, living hinges and soft robots).

### SUMMARY OF THE DISCLOSURE

The present disclosure provides polymer compositions and methods of making 3D structures. This disclosure also provides 3D printers.

This disclosure allows for the rapid fabrication of high-resolution silicone (e.g., polydimethylsiloxane) based elastomeric devices via 3D printing (e.g., stereolithography). Stereolithography is an additive manufacturing technique that uses selective photoirradiation to cure a liquid resin of photopolymerizable material. FIG. 9A shows a schematic of a bottom-up SLA printer where patterned light travels through a transparent window onto the base of a vat of liquid photopolymer, curing and adhering it to the build stage or previously printed layer. By repeating this process, layer-by-layer, a solid object is fabricated. Compared to other additive manufacturing techniques, stereolithography is attractive because of its rapid build speed, micron resolution, and scalability.

In an aspect, the present disclosure provides polymer compositions. The polymer compositions can be used in 3D printing methods (e.g., stereolithography methods). The polymer compositions can be referred to as resins. The polymer compositions can be used in 3D printing methods (e.g., stereolithography methods) disclosed herein or known in the art.

A polymer composition comprises one or more vinyl polymer components, one or more thiol polymer components, and one or more photoinitiator(s). For example, a polymer composition comprises: a) a first polymer component (e.g., a vinyl polymer component); b) a second polymer component (e.g., a thiol polymer component); c) a photoinitiator.

A vinyl polymer component comprises a plurality of vinyl groups. A vinyl polymer component can be a siloxane polymer comprising a plurality of vinyl groups.

A thiol polymer component comprises a plurality of thiol groups. A thiol polymer component can be a siloxane polymer comprising a plurality of thiol groups.

In an aspect, the present disclosure provides 3D objects. The 3D objects can a wide range of sizes, shapes, and morphologies. The 3D objects can be a soft, stretchable objects. The 3D objects can be hollow. The 3D objects are elastomeric. The 3D objects can exhibit desirable optical properties. The 3D objects can exhibit desirable mechanical properties.

In various examples, the 3D objects are soft, robotic or biomedical devices, such as, for example, fluidic elastomer actuators, antagonistic pairs of fluidic elastomer actuators, springs, living hinges, left atrial appendage occluders, valves.

In an aspect, the present disclosure provides methods of making 3D structures using one or more polymer compositions of the present disclosure. The methods are based on the irradiation of a layer of a polymer composition of the present disclosure. On irradiation a vinyl group reacts with a thiol group to form an alkeynyl sulfide (i.e., a vinyl group and thiol group undergoes a hydrothiolation reaction). A 3D structure can be formed by repeated irradiation of discrete layers.

For example, a method of making a 3D structure comprises a) exposing a layer of a polymer composition of the present disclosure to electromagnetic radiation such that at least a portion of the first component and second component in the layer react (e.g., polymerize) to form a polymerized portion of the layer; b) optionally, forming a second layer of a polymer composition of the present disclosure disposed on at least a portion of the polymerized portion of the previously formed polymerized portion (e.g., of the present disclosure and exposing the second layer of a polymer composition to electromagnetic radiation such that at least a portion of the first component and second component in the layer react (e.g., polymerize) to form a second polymerized portion of the second layer; and c) optionally, repeating the forming and exposing from b) a desired number of times, where a 3D structure is formed.

In an aspect, the present disclosure provides 3D printers. The 3D printers have a build window that comprises an organic polymer film. The build window is a solid, translucent layer that allows light to enter the resin vat and photopolymerize the liquid resin. The cured material preferentially adheres to the build stage or printed resin and can be delaminated from the build window.

A build window comprises an organic polymer film or an organic polymer film disposed on at least a portion (or all) of a surface of a build window (e.g., glass such as, for example, quartz) that is in contact with a resin.

### BRIEF DESCRIPTION OF THE FIGURES

For a fuller understanding of the nature and objects of the disclosure, reference should be made to the following detailed description taken in conjunction with the accompanying figures.

FIG. 1 shows reaction schema showing branched mercaptopropylmethyl dimethylsiloxanes copolymers of varying thiol density and vinyl terminated polydimethylsiloxanes of varying molecular weights photopolymerizing to yield different polymer microstructures.

FIG. 2 shows a UV digital mask projection stereolithography printer modified to contain a polymethylpentene (PMP) build window.

FIG. 3 shows representative tensile data of 1:1 stoichiometric (SH: C═C) blends of mercaptopropylmethylsiloxan-dimethylsiloxane copolymer with vinyl terminated polydimethylsiloxane. The naming convention is XX % YYYYY where XX is the relative density of mercaptopropyl groups along the mercaptopropylmethylsiloxan-dimethylsiloxane copolymer and YYYYY is the number averaged molecular weight of the vinyl terminated polydimethylsiloxane.

FIG. 4 shows photorheology data by resin composition. Cyclic tests for three (1:1) stoichiometric (SH: C═C) blends of mercaptopropylmethylsiloxan-dimethylsiloxane copolymer with vinyl terminated polydimethylsiloxane. The naming convention is XX % YYYYY where XX is the relative density of mercaptopropyl groups along the mercaptopropylmethylsiloxan-dimethylsiloxane copolymer and YYYYY is the number averaged molecular weight of the vinyl terminated polydimethylsiloxane.

FIG. 5 shows summary data of the photorheological and mechanical data for 1:1 stoichiometric blends of mercaptopropylmethylsiloxan-dimethylsiloxane copolymer with vinyl terminated polydimethylsiloxane. The naming convention is XX % YYYYY where XX is the relative density of mercaptopropyl groups along the mercaptopropylmethylsiloxan-dimethylsiloxane copolymer and YYYYY is the number averaged molecular weight of the vinyl terminated polydimethylsiloxane

FIG. 6 shows Stanford bunny model printed on a modified ember by Autodesk printer with 2.5%6000 resin. Elastomeric properties are shown by the object's ability to return to its original shape after deformation.

FIG. 7 shows structures printed with described elastomeric resins on a modified Autodesk by ember printer.

FIG. 8 shows printed “Touchdown the Bear” using an ember by Autodesk printer and 2.5%186 resin.

FIG. 9 shows an overview of the stereolithography printer, thiol-ene photochemistry and printed demonstrations. (A) A bottom-up SLA printer showing a 3D solid object forming under exposure to patterned light. (B) Photopolymerization reaction schema. Appropriate selection of the M.S. thiol density and molecular weight of V.S. permit tuning of the polymer network. As printed (C) NSF Logo from 2.5%17200 resin, Cornell University's Touchdown the Bear mascot with hollow center from 5%6000 resin (D) before (E) during and (F) after manipulation

FIG. 10 show photopolymerization behavior of select resins. The time-evolution of the resin's complex viscosity (A) and storage and loss moduli (B) under photoexposure (Eₑ=10 mW·cm⁻², λ=400-500 nm).

FIG. 11 shows mechanical Behavior of the photopolymerized resins. (A) Representative data of tensile tests to failure for all blends. (B) Cyclic tensile tests to 75% of the ultimate elongation. Printed Kagome Tower structures under different compressive loads: (C) 5%6000 material at F=0 N; (D) 5%186 at F=1 N; (E) 5%6000 at F=1N; (F) 2.5%6000 at F=1 N.

FIG. 12 shows a monolithic device as printed from the 5%6000 resin with a pair of antagonistic FEAs with: (A) both chambers deflated; (B) both chambers inflated; (C) both chambers evacuated; (D) and (E) one chamber inflated and the other evacuated.

FIG. 13 shows synthetic antagonistic muscle actuator printed from the 2.5%186 resin: (a) pressurized with low-viscosity prepolymer resin; (b) pierced by a scalpel; (c) pressurized fluid draining; (d) autonomic self-healing via ambient sunlight in the relaxed state for 30 seconds (e) returning to its original actuated state (dashed line) with re-pressurization.

FIG. 14 show the contact angle between water and PMP Windows before and after 100 s of hours of use in the printer.

FIG. 15 shows 3D laser confocal microscopy of monolithic device of antagonistic FEAs. The blue line is parallel to build direction (z-axis).

FIG. 16 shows photopolymerization behavior for examples of resins. The time-evolution of the complex viscosity for resins based on (a) 2.5% and (b) 5% poly-mercaptopropylmethylsiloxane-co-dimethylsiloxane. The time evolution in the storage and loss moduli under photoexposure for (c) 2.5% and (d) 5% poly-mercaptopropylmethylsiloxane-co-dimethylsiloxane.

FIG. 17 shows normalized heat flow vs. illumination time graphs for the blends based on (a) 2.5% and (b) 5% poly-mercaptopropylmethylsiloxane-co-dimethylsiloxane

FIG. 18 shows a Stanford bunny model printed from 2.5%6000 material without incorporation of an absorptive species. This complaint structure is shown (a) before, (b) during, and (c) after manipulation and (d) the absorption of the individual components of our resin system

FIG. 19 shows a schematic of a synthetic antagonist muscle device. Fluidic channels are colored dark gray, printed siloxanes are colored light gray.

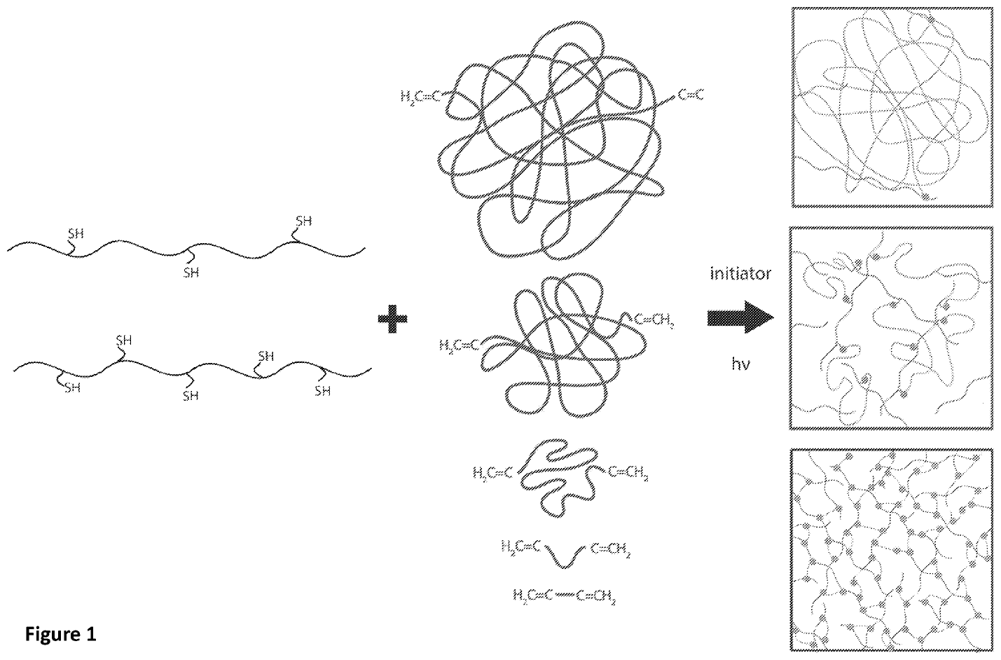

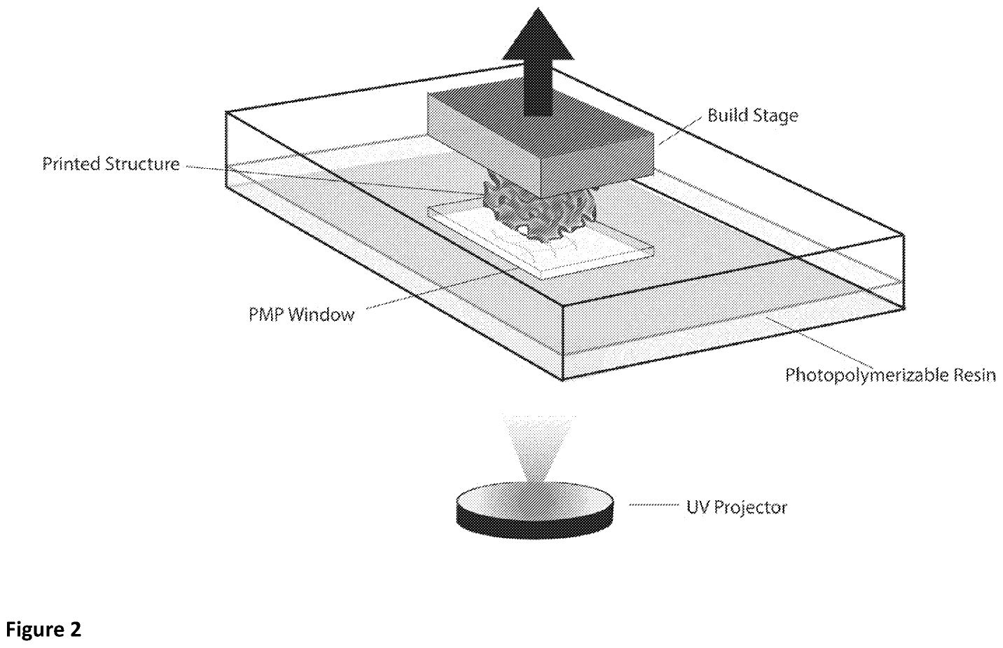

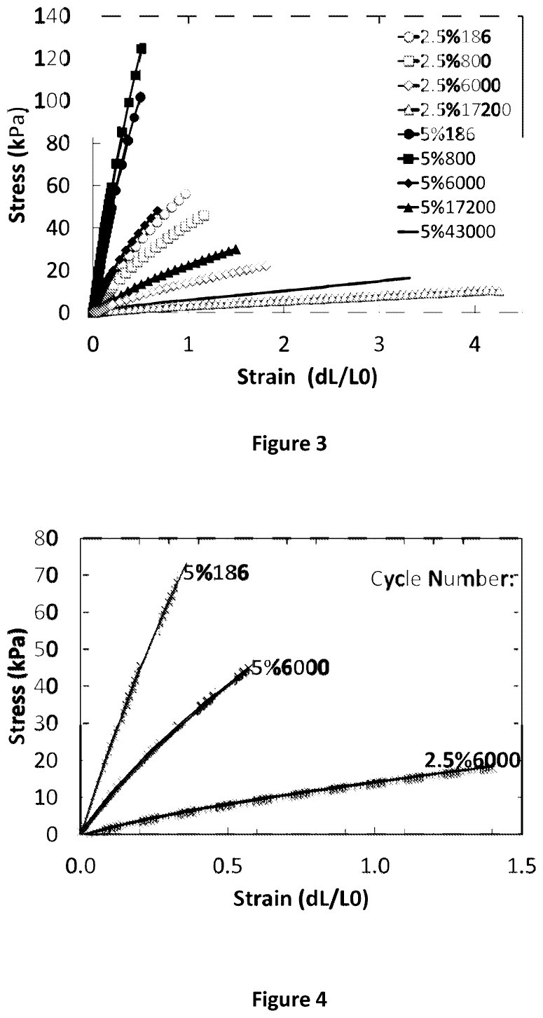

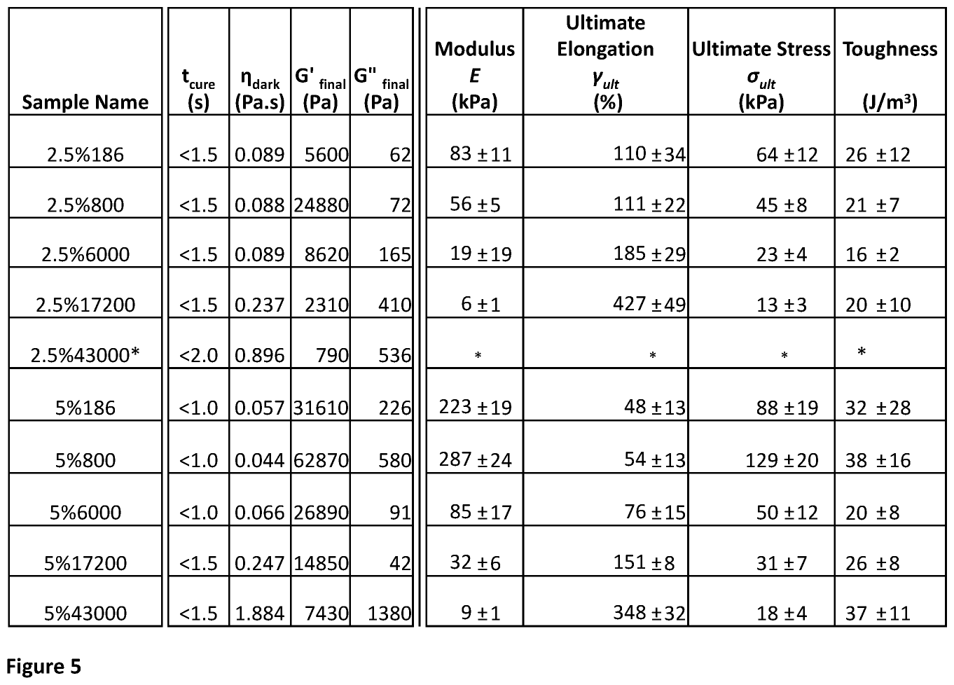

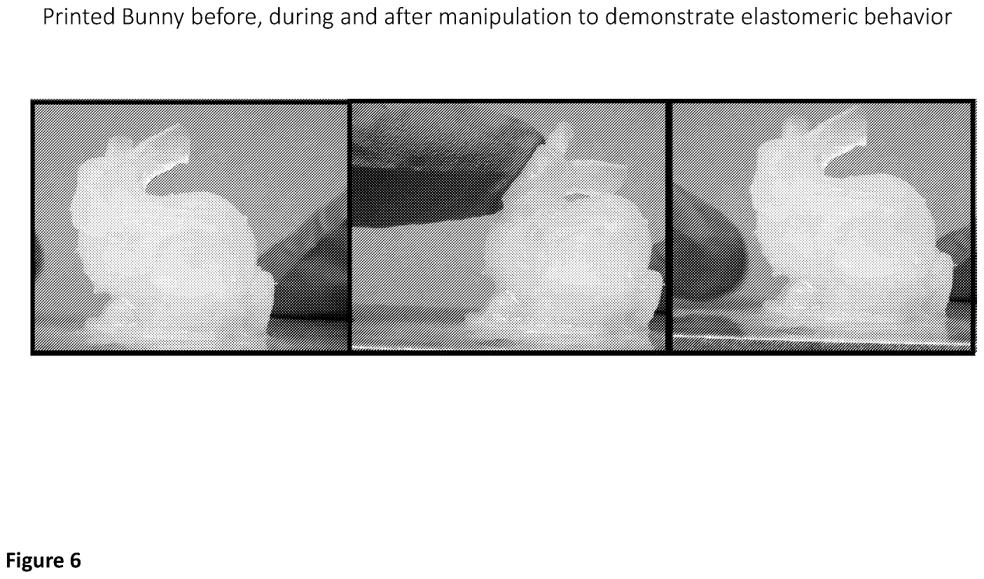

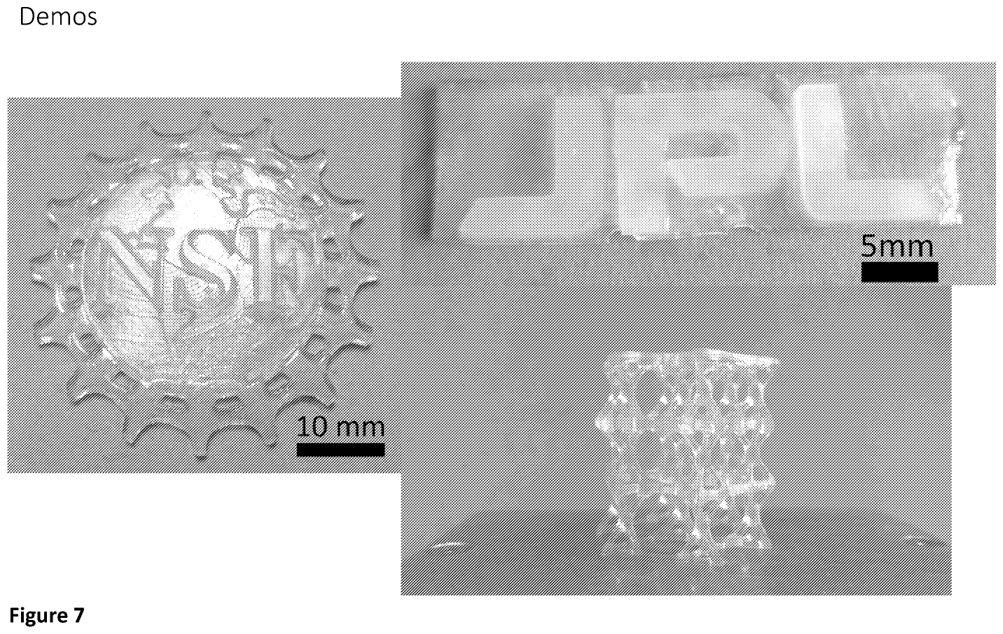

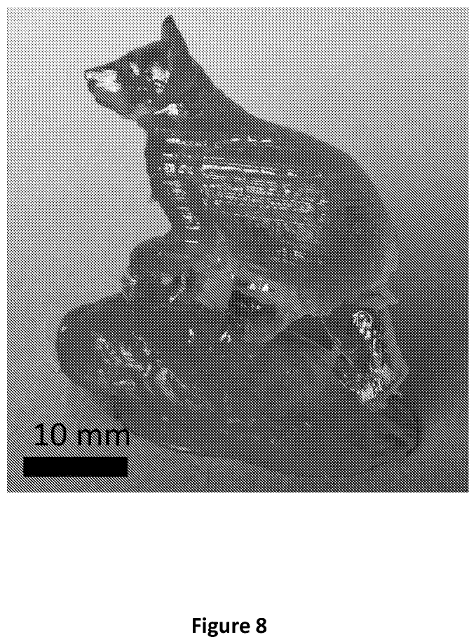

### DETAILED DESCRIPTION OF THE DISCLOSURE

Although claimed subject matter will be described in terms of certain embodiments and examples, other embodiments and examples, including embodiments and examples that do not provide all of the benefits and features set forth herein, are also within the scope of this disclosure. Various structural, logical, and process step changes may be made without departing from the scope of the disclosure.

Ranges of values are disclosed herein. All ranges provided herein include all values that fall within the ranges to the tenth decimal place, unless indicated otherwise and ranges between the values of the stated range.

The present disclosure provides polymer compositions and methods of making 3D structures and 3D objects. This disclosure also provides 3D printers.

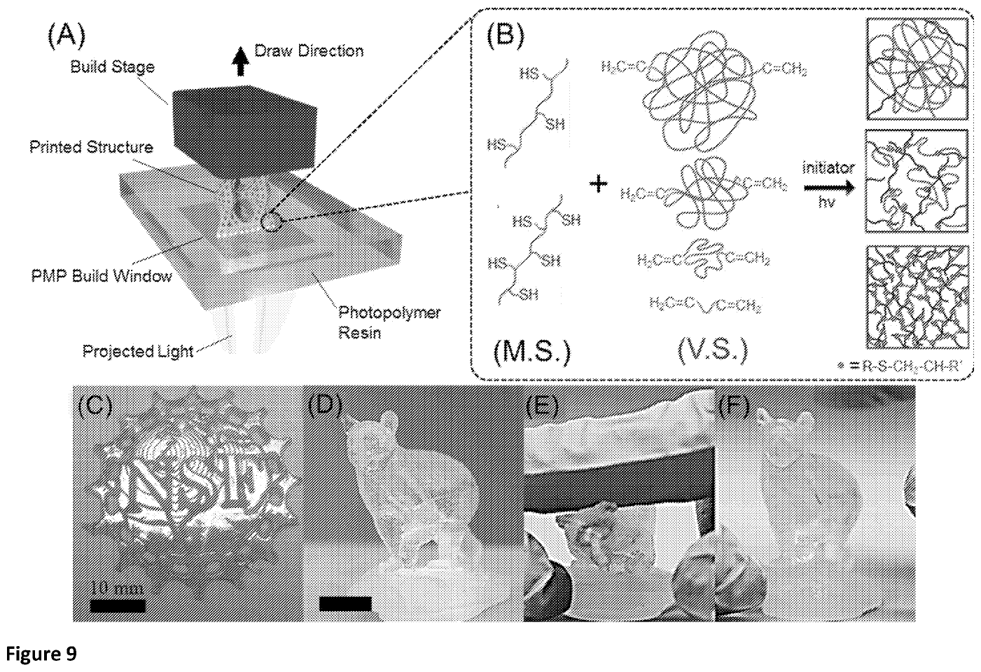

This disclosure allows for the rapid fabrication of high-resolution silicone (e.g., polydimethylsiloxane) based elastomeric devices via 3D printing (e.g., stereolithography). Stereolithography is an additive manufacturing technique that uses selective photoirradiation to cure a liquid resin of photopolymerizable material. FIG. 9A shows a schematic of a bottom-up SLA printer where patterned light travels through a transparent window onto the base of a vat of liquid photopolymer, curing and adhering it to the build stage or previously printed layer. By repeating this process, layer-by-layer, an object (e.g., a solid object) is fabricated. Compared to other additive manufacturing techniques, stereolithography is attractive because of its rapid build speed, micron resolution, and scalability.

This disclosure permits the rapid fabrication of elastomeric silicones with a wide range of mechanical properties including the capability to elastically deform far further than previously reported stereolithographic resins. Using the compositions and methods of the present disclosure, one can rapidly photopolymerize silicone from polydimethylsiloxane copolymers bearing thiol and vinyl side groups. Controlling the molecular weight and relative density of these side groups permits, for example, a wide range of elastic moduli, toughnesses, and ultimate elongations in the cured material.

The polymer compositions of the present disclosure and 3D objects made using the polymer compositions have numerous applications and uses. The polymer compositions of the present disclosure provide attractive elastomeric stereolithography chemistries. Thiolene based silicones provide chemical stability, offer tunability and can outperform resins previously known in the art. For example, soft robotics is a field that needs to fabricate high resolution architectures of elastomeric materials. The ability to rapidly fabricate elastomeric silicones into complex geometries also stands to be a disruptive force in biomedical devices. Silicones are common materials for biomedical devices, and the instant thiolene based PDMS chemistries are potentially less cytotoxic than their stereolithography counterparts.

Thiol-ene chemistry, or alkyl hydrothiolation, which can be photo-initiated, results in the formation of an alkyl sulfide from a thiol and alkene as shown in Eq. 1.

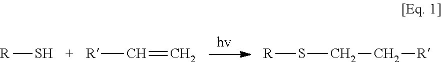

This is a highly exothermic reaction that proceeds rapidly and in high yield. Photoiniated thiol-ene reactions yield homogenous polymer networks that can show reduced shrinkage and exhibit a rapid increase in gel fraction over a small photodosages. Unlike CGP of acrylates, where undesired propagation reactions can continue for days after gelation, the free radical generated on the alkene is immediately satisfied by a hydrogen abstraction from the thiol. This step-growth polymerization (FIG. 9B) and desirable conversion combine to provide control of the resulting photopolymer's network density, and thereby mechanical properties.

Without the ability to kinetically stabilize or quench free radicals, click-reactions are incompatible with oxygen-inhibited methods for delamination from window substrates likely explaining the lack of SLA printed elastomers from known thiol-ene chemistries. To circumvent this issue, prior work on printing tightly crosslinked pre-ceramics employed a floating layer of fluorosiloxane lubricant above a polydimethylsiloxane (PDMS) window. The transient nature of this liquid layer limits the printed objects to short build heights (˜2 cm) and low cross sectional areas. Additionally, the commonly used PDMS window coating absorbs species from the resin which cloud the window over time, reducing light flux and photopatterning resolution. The present disclosure also provides elastomeric thiol-ene material chemistries for SLA by using a new, low surface energy, high transparency poly-4-methylpentene-1 (PMP) build window that allows for easy delamination of printed parts and does not degrade over time.

In an aspect, the present disclosure provides polymer compositions. The polymer compositions can be used in 3D printing methods (e.g., stereolithography methods). The polymer compositions can be referred to as resins. The polymer compositions can be used in 3D printing methods (e.g., stereolithography methods) disclosed herein or known in the art.

A polymer composition comprises one or more vinyl polymer components, one or more thiol polymer components, and one or more photoinitiator(s). For example, a polymer composition comprises: a) a first polymer component (e.g., a vinyl polymer component); b) a second polymer component (e.g., a thiol polymer component); c) a photoinitiator. A polymer component can be a functionalized silicone (e.g., functionalized siloxane polymers such as, for example, thiol group or vinyl group functionalized siloxane polymers). A silioxane polymer can be a siloxane copolymer. Examples of functionalized siloxane copolymers include, but are not limited to, functionalized siloxane copolymers such as, for example, mercaptopropyl(methylsiloxane)-dimethylsiloxane copolymers.

A vinyl polymer component comprises a plurality of vinyl groups. The vinyl groups can be terminal groups. The vinyl groups can undergo an alkyl hydrothiolation reaction. The polymer component is an elastomer. For example, the vinyl polymer component has 2 to 30 vinyl groups, including all integer number of vinyl groups and ranges therebetween.

A vinyl polymer component can be a siloxane polymer comprising a plurality of vinyl groups. The vinyl groups can be terminal vinyl groups, pendant vinyl groups, or a combination thereof. The vinyl groups can be randomly distributed or distributed in an ordered manner on individual siloxane polymer chains. The siloxane polymer can be linear or branched. For example, the siloxane polymer can have a molecular weight (Mn or Mw) of 186 g/mol to 50,000 g/mol, including all integer g/mol values and ranges there between. In another example, the siloxane polymer can have a molecular weight (Mn or Mw) of 186 g/mol to 175,000 g/mol, including all integer g/mol values and ranges there between. Examples of vinyl polymer components are disclosed herein. Suitable vinyl polymer components are commercially available and can be made using methods known in the art.

A thiol polymer component comprises a plurality of thiol groups. The thiol groups can be terminal groups. The thiol polymer component and thiol groups can be referred to as mercapto polymer components and mercapto groups, respectively. The thiol groups can undergo an alkyl hydrothiolation reaction. The polymer component is an elastomer. For example, the thiol polymer component has 2 to 30 thiol groups, including all integer number of thiol groups and ranges therebetween.

A thiol polymer component can be a siloxane polymer comprising a plurality of thiol groups. In an example, a siloxane polymer is a (mercaptoalkyl)methylsiloxane-dimethylsiloxane copolymer, where, for example, the alkyl group is a C₁ to C₁₁ alkyl group. A non-limiting example of a (mercaptoalkyl)methylsiloxane-dimethylsiloxane copolymer is mercaptopropyl(methylsiloxane)-dimethylsiloxane copolymer. The thiol groups can be terminal groups, pendant groups, or a combination thereof. The thiol groups can be randomly distributed or distributed in an ordered manner on the individual siloxane polymer chains. The siloxane polymer can be linear or branched. For example, the siloxane polymer can have a molecular weight (Mn or Mw) of 186 g/mol to 50,000 g/mol, including all 0.1 g/mol values and ranges therebetween. In another example, the siloxane polymer can have a molecular weight (Mn or Mw) of 186 g/mol to 175,000 g/mol, including all 0.1 g/mol values and ranges therebetween. For example, the siloxane polymer can have a molecular weight (Mn or Mw) of 268 g/mol to 50,000 g/mol, including all 0.1 g/mol values and ranges therebetween. In another example, the siloxane polymer can have a molecular weight (Mn or Mw) of 268 g/mol to 175,000 g/mol, including all 0.1 g/mol values and ranges therebetween. Examples of thiol polymer components are disclosed herein. Suitable thiol polymer components are commercially available and can be made using methods known in the art.

A thiol polymer component (e.g., a siloxane polymer comprising a plurality of thiol groups) can have various amounts of thiol groups. In various examples, a thiol polymer component (e.g., a siloxane polymer comprising a plurality of thiol groups) has 0.1-6 mol % thiol groups, including all 0.1 mol % values and ranges therebetween. In various examples, a thiol polymer component (e.g., a siloxane polymer comprising a plurality of thiol groups) has 0.1-5 mol %, 0.1-4.9 mol %, 0.1-4.5 mol % thiol groups, 0.1-4 mol %, or 0.1-3 mol % thiol groups. In various examples, a thiol polymer component (e.g., a siloxane polymer comprising a plurality of thiol groups) has 0.5-5 mol %, 0.5-4.9 mol %, 0.5-4.5 mol % thiol groups, 0.5-4 mol %, or 0.5-3 mol % thiol groups.

For example, the siloxane polymer is a poly-(mercaptopropyl)methylsiloxane-co-dimethylsiloxane polymer. In various examples, this polymer system has 2-3 mole % or 4-6 mole % mercaptopropyl groups with a total molecular weight of 6000-8000. The pendant mercaptopropyl groups are located randomly among the siloxane backbone. For example, the alkenes used in the thiolene chemistry are low viscosity polydimethylsiloxanes terminated on both ends by vinyl (—CH═CH₂) groups with total molecular weights (Mn) of, for example, 186, 500, 6000, 17200, or 43000. These components are added in, for example, a 1:1 stoichiometric ratio of mercaptopropyl to vinyl groups depending on the desired mechanical properties of the resulting object (See Table 1). To this blend, a photoinitiator (e.g., 10% by weight of a 100 mg/mL diphenyl(2,4,6-trimethylbenzoyl)phosphine oxide in toluene) is added. Centrifugal mixing at, for example, 2000 rpm for 30 seconds provides a homogenous mixture, particularly for the high molecular weight components. A small amount (0.5% by weight) of absorptive species, like Sudan Red G, can be added as a photoblocker to limit cure depth to the desired build layer height.

Herein, polymer compositions can be referred to by the molar fraction of thiol groups followed by the molecular weight of the vinyl PDMS (e.g. 2.5%17200 is a blend of 2-3% poly-(mercaptopropyl)methylsiloxane-co-dimethylsiloxane and vinyl terminated polydimethylsiloxane with a molecular weight of 17,200).

The vinyl polymer component and/or thiol polymer component can have one or more non-reactive side groups (e.g., groups that do not react in a reaction used to pattern the polymer composition). Examples of non-reactive side groups include, but are not limited to, alkyl groups and substituted alkyl groups such as, for example, methyl, ethyl, propyl, phenyl, and trifluoropropyl groups.

The polymer composition can comprise a plurality of different vinyl polymer components and/or a plurality of thiol polymer components. A polymer composition can comprise linear and/or branched vinyl polymer components and/or linear or branched thiol polymer components. It is desirable that the composition comprise at least one branched monomer unit (e.g., one or more branched vinyl polymer component and/or one or more branched thiol polymer component) which can form a network structure. It is considered that by using different combinations of linear and/or branched polymer components polymerized materials (e.g., 3D printed structures) can have different properties (e.g., mechanical properties).

For example, a polymer composition comprises mix one or more branched polymer species (<2 thiol/vinyl units) with two or more linear polymers species (two thiol groups/two vinyl units). An example is shown simply below. In this case, it may be desirable that the stoichiometry between the branched unit functional group (e.g., A in the following reaction scheme) and the linear unit functional groups (e.g., B in the following reaction scheme) does not exceed 1:50.

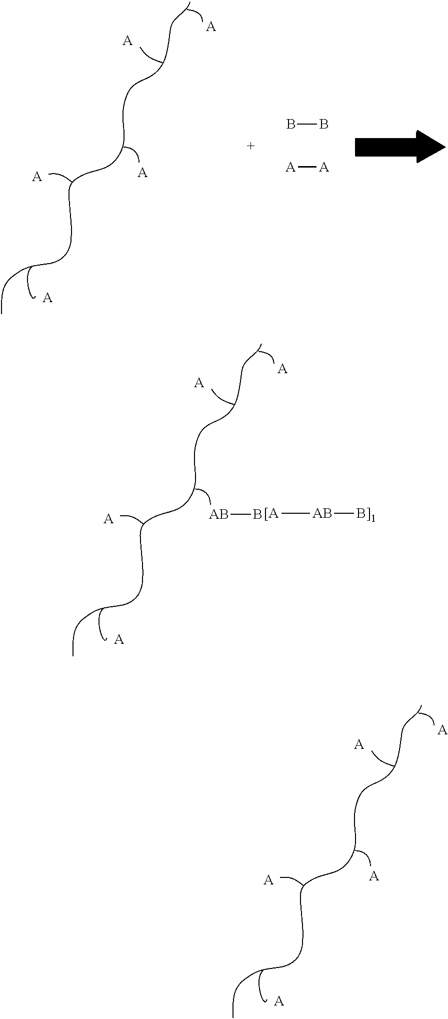

The amount of vinyl polymer component(s) and thiol polymer component(s) can vary. The individual polymer components can be present at 0.5% to 99.5% by weight, including all 0.1% values and ranges therebetween. In various examples, the vinyl polymer component(s) are present at 3% to 85% by weight and/or the thiol polymer component(s) are present at 15% to 97% by weight. In the examples, the stoichiometric ratio of thiol groups to vinyl groups in the polymer composition is 1:1. In various other examples, the stoichiometric ratio of thiol groups to vinyl groups in the polymer composition is from 26:1 to 1:26, 20:1 to 1:20, 15:1 to 1:15, 10:1 to 1:10, 5:1 to 1:5, 4:1 to 1:4, 3:1 to 1:3, or 2:1 to 1:2. These changes can yield different mechanical properties by affecting, for example, the crosslink density, distance between crosslinks, and degree of polymerization for the printed material.

The total amount of polymer components in the compositions can vary. For example, a composition of the present disclosure has 10 to 99.99% by weight polymer components, including all 0.01 values and ranges therebetween.

For 3D printing applications, it is desirable that dynamic viscosity of the polymer composition is 5 Pa·s or less. For example, addition (e.g., less than 80% by volume) of a low viscosity diluent/solvent can lower the viscosity below this threshold. The viscosity could also be lowered by raising the build temperature with a heat source in the resin vat. Using such strategies polydimethylsiloxane molecular weights of up to and including 175,000 g/mol can be used that can yield even softer, more extensible materials that those produced using lower molecular weight polymers.

Various photoinitiators can be used. Mixtures of photoinitiators can be used. The chemistry of the materials in the polymer composition is not dependent on the type of or specific photoinitiator used. It is desirable that the photoinitiator and polymer components are at least partially miscible in each other or a suitable solvent system. It is desirable that the absorption of the photoinitiator overlap with the wavelength (e.g., 300 to 800 nm) of the irradiation source (e.g., stereolithography source) used to photocure the polymer composition. Examples of photoinitiators are disclosed herein. Examples of photoinitiators include, but are not limited to, UV Type I photoinitiators, UV Type II, and visible photoinitiators. Examples of UV Type I photoinitiators include, but are not limited to, benzoin ethers, benzyl ketals, α-dialkoxy-acetophenones, α-hydroxy-alkyl-phenones, α-amino alkyl-phenones, acyl-phosphine oxides, and derivatives thereof. Examples of UV Type II photoinitiators include, but are not limited to, include benzo-phenones/amines, thio-xanthones/amines, and derivatives thereof. Examples of visible photoinitiators include, but are not limited to titanocenes, flavins and derivatives thereof. Photoinitiator(s) can be present at various amounts in the compositions. In various examples, photoinitiator(s) are present in the polymer composition at 0.01 to 10% by weight, including all 0.01% values and ranges therebetween, based on the weight of polymer components and photoinitiator(s) in a composition. Examples of photoinitiators are commercially available or can be made using methods known in the art.

A polymer composition can further comprise one or more solvents. Examples of solvents include, but are not limited to, toluene, tetrahydrofuran, hexane, acetone, ethanol, water, dimethyl sulfoxide, pentane, cyclopentane, cyclohexane, benzene, chloroform, diethyl ether, dichloromethane, ethyl acetate, dimethylformamide, methanol, isopropanol, n-proponal, and butanol.

A polymer composition can further comprise one or more additives. Examples of additives include, but are not limited to, diluents, non-reactive additives, nanoparticles, absorptive compounds, and combinations thereof. For example, an absorptive compounds is a dye, which, if they absorb in the spectral range used to polymerize the polymer composition can be photoblockers, such as, for example, Sudan Red G). It is desirable that the additives be soluble in the polymer composition. Examples of additives include, but are not limited to, metallic nanoparticles such as, for example, iron, gold, silver and platinum, oxide nanoparticles such as for example, iron oxide (Fe₃O₄ and Fe₂O₃), silica (SiO₂), and titania (TiO₂), diluents such as, for example, silicone fluids (e.g., hexamethyldisiloxane and polydimethysiloxane), non-reactive additives or fillers such as, for example, calcium carbonates, silica, and clays, absorptive compounds such as, for example, pigments (e.g., pigments sold under the commercial name “Silc Pig” such as, for example, titanium dioxide, unbleached titanium, yellow iron oxide, mixed oxides, red iron oxide, black iron oxide, quinacridone magenta, anthraquinone red, pyrrole red, disazo scarlet, azo orange, arylide yellow, quinophthalone yellow, chromium oxide green, phthalocyanine cyan, phthalocyanine blue, cobalt blue, carbazole violet and carbon black).

Polymer compositions can be made by mixing (e.g., using centrifugation) the individual components together. Examples of making polymer compositions are disclosed herein. Solvents (as described herein) can used to improve mixability of components.

Examples of polymer compositions and photocuring behavior of the polymer compositions and mechanical properties of the photocured polymer compositions are provided in the following table:

TABLE 1
Resin Composition with Photocuring Behavior and Mechanical Properties

| Mercaptopropyl | | | | | | | |
|---|---|---|---|---|---|---|---|
| PDMS | | | | | | | |
| (MWT: 4000- | | Vinyl terminated | | | | | |
| 6000) | | PDMS | | | Uncured | Elastic | |
| Mole | Amount | Molecular | Amount | Cure time | Viscosity^{‡} | Modulus | Elongation at |
| % | added (g) | Weight | added (g) | t_{cure} (s)* | η (Pa.s) | (kPa) | Break (%) |
| 2-3% | 970 | 186 | 30 | <1.5 | 0.089 | 83 ± 11 | 110 ± 34 |
| 2-3% | 884 | 500 | 116 | <1.5 | 0.088 | 56 ± 5 | 111 ± 22 |
| 2-3% | 502 | 6000 | 498 | <1.5 | 0.089 | 19 ± 5 | 185 ± 29 |
| 2-3% | 260 | 17600 | 740 | <1.5 | 0.237 | 6 ± 1 | 427 ± 49 |
| 4-6% | 942 | 186 | 58 | <1.0 | 0.057 | 239 ± 25 | 56 ± 19 |
| 4-6% | 794 | 500 | 206 | <1.0 | 0.044 | 294 ± 28 | 56 ± 13 |
| 4-6% | 338 | 6000 | 662 | <1.0 | 0.066 | 85 ± 17 | 76 ± 15 |
| 4-6% | 152 | 17600 | 848 | <1.5 | 0.247 | 32 ± 6 | 151 ± 8 |
| 4-6% | 66 | 43000 | 934 | <1.5 | 1.884 | 9 ± 1 | 348 ± 32 |

*Determined by crossover of storage and loss modulus at 9 mW/cm² of 400-410 nm UV light
^{‡}Determined via rheology at 1% amplitude and 1 Hz oscillation

The polymer compositions can be used in 3D printing methods (e.g., 3D methods of the present disclosure), for example, to provide 3D objects. For example, a polymer composition is placed into the build tray of a stereolithographic printer with an output spectrum compatible with the photoinitiating system (200-420 nm), such as, for example, Ember by Autodesk and the like. A 3D object can be fabricated according to desired print parameters.

The 3D objects can a wide range of sizes, shapes, and morphologies. The 3D objects can be soft, stretchable objects. The 3D objects can be solid, hollow, partially hollow, or a combination thereof. The 3D objects are elastomeric. The 3D object can comprise a polysiloxane polymer or a plurality of polysiloxane polymers. The 3D object can comprise a plurality of siloxane polymer chains.

The 3D objects can exhibit desirable optical properties. For example, 3D objects (e.g., photocured objects) exhibit <90% transmission over visible wavelengths (400<λ<750 nm). Desired absorptivity, or coloration, in printed objects could therefore be imparted by the addition of dye species.

The 3D objects can exhibit desirable mechanical properties. 3D objects (e.g., photocured objects) objects can display elastic moduli, or Young's Moduli at 2% strain, E, of 6 kPa to 300 kPa, including all integer kPa values and ranges therebetween, and/or elongations at break, γᵤₗₜ, (dL/L₀) of 56% to 427%, including all integer % values and ranges therebetween. A 3D object can have a Young's Moduli of 6 kPa to 287 kPa or greater, including all integer kPa values and ranges therebetween. A 3D object can have an ultimate elongation of 48% to 427%, including all integer % values and ranges therebetween. In an example, an object has a Young's Moduli of 6 kPa to 287 kPa or greater and an ultimate elongation of 48% to 427%. These materials (e.g., 3D objects) show desirable fatigue life, e.g., surviving over 100 cycles to 75% of their ultimate elongations.

In various non-limiting examples, the 3D objects are soft, robotic or biomedical devices. Non-limiting examples of 3D objects include fluidic elastomer actuators, antagonistic pairs of fluidic elastomer actuators, springs, living hinges, left atrial appendage occluders, valves, and the like.

In an aspect, the present disclosure provides methods of making 3D structures (e.g., 3D objects) using one or more polymer compositions of the present disclosure. In an example, a method is not a continuous pull method.

The methods are based on the irradiation of a layer of a polymer composition of the present disclosure. On irradiation a vinyl group reacts with a thiol group to form an alkeynyl sulfide (i.e., a vinyl group and thiol group undergoes a hydrothiolation reaction). A 3D structure can be formed by repeated irradiation of discrete layers.

The methods are not based on oxygen inhibition. In an example, a method is carried out in an atmosphere comprising oxygen. In an example, a method does not comprise removing oxygen from the atmosphere or composition (e.g., resin) in which the radiation is carried out.

For example, a method of making a 3D structure comprises a) exposing a layer of a polymer composition of the present disclosure to electromagnetic radiation such that at least a portion of the first component and second component in the layer react (e.g., polymerize) to form a polymerized portion of the layer; b) optionally, forming a second layer of a polymer composition of the present disclosure disposed on at least a portion of the polymerized portion of the previously formed polymerized portion (e.g., of the present disclosure and exposing the second layer of a polymer composition to electromagnetic radiation such that at least a portion of the first component and second component in the layer react (e.g., polymerize) to form a second polymerized portion of the second layer; and c) optionally, repeating the forming and exposing from b) a desired number of times, so that a 3D structure is formed.

The exposing (or illumination) of a polymer composition layer can be performed as a blanket (i.e., flood) exposure or a patterned (e.g., lithographic or direct write) exposure. For example, the exposing is carried out using stereolithography. Electromagnetic radiation used in the exposing can have a wavelength or wavelengths from 300 to 800 nm, including all integer values and ranges therebetween. In various examples, the exposing (or illumination) is carried out using UV LED lights or lasers (e.g., such as those found in Ember by Autodesk and Formlabs 1, 1+ and 2 printers (405 nm)) or mercury and metal halide lamps (e.g., such as those found in high definition projectors (300-800 nm).

The exposing (or illumination) of a polymer composition layer can be carried out for various times. In various examples, the exposing (or illumination) is carried out for 0.2-20 seconds, including all 0.1 second values and ranges therebetween. A required exposure time depends on print parameters such as, for example: layer height, cross sectional area, power intensity of the printer, wavelength of light source, concentration of photoinitiator, etc.

Use of the polymer compositions of the present disclosure, which can participate in thiol-ene click reactions, can exhibit gelation at low photodosages. As an illustrative example, a polymer composition comprising 33.8% by weight 4% mercaptopropylmethylsiloxane-copolydimethylsiloxane and 66.2% by weight vinyl terminated polydimethylsiloxane (Mn=6,000) gels after less than 20 mW/cm² of exposure to 400-500 nm light.

The thickness of the layer(s) of polymer composition can vary. For example, the thickness of the layer(s) of polymer composition are, independently, from 0.1 microns to 10,000 microns, including all 0.1 micron values and ranges therebetween.

The methods (e.g., exposing and/or layer formation) can be carried out with a 3D printer. Examples of types of 3D printers include, but are not limited to, Digital Mask Projection stereolithography (e.g., Ember by Autodesk, Phoenix Touch Pro UV DLP SLA), micro-stereolithography printers, and laser based direct-write stereolithography systems (e.g., FormLabs form 1, 1+, and 2, Pegasus Touch Laser SLA, Materialise Mammoth).

The steps of the methods described in the various embodiments and examples disclosed herein are sufficient to carry out the method of the present disclosure. Thus, in an example, a method consists essentially of a combination of steps of the methods disclosed herein. In another example, a method consists of such steps.

In an aspect, the present disclosure provides 3D printers. The 3D printers have a build window that comprises an organic polymer film. The build window is a solid, translucent layer that allows light to enter the resin vat and photopolymerize the liquid resin. The cured material preferentially adheres to the build stage or printed resin and can be delaminated from the build window.

A build window comprises an organic polymer film or an organic polymer film disposed on at least a portion (or all) of a surface of a build window (e.g., glass such as, for example, quartz) that is in contact with a resin.

A build window has desirable properties. For example, has one, a combination of, or all of the following properties:

optical transparency (e.g., greater than 80% or greater than 90% transmission at 300 to 800 nm or 400 nm to 800 nm);

Releasability and non-compatibility with respect to a resin material (e.g., a polymer composition of the present disclosure). The organic polymer has a surface energy such that a polymer composition (e.g., a polymer composition of the present disclosure) does not adhere to the surface of a film of the organic polymer. For example, the surface tension is 50 mN/m or less. It is desirable to minimize VanDer Waals forces, hydrogen bonding, ionic bonding and covalent bonding between the build window and resin material;

Chemically resistant, that is able to withstand prolonged exposure (e.g., 50 hours or less) to common and organic solvents without showing discoloration, a change in optical transmission, softening, or blistering. Common aqueous and organic solvents including, for example, toluene, tetrahydrofuran, dimethyl, water, ethanol, methanol, and dimethyl sulfoxide;

a yield stress, for example, 1 kPa or greater from −30° C. to 200° C., such that the build window can support a resin vat; and

low swelling ratios (e.g., 1% or less by weight) in common solvents (e.g., as mentioned above with respect to chemical resistance), printed resins and dyes. This ensures the transparency, non-compatibility and releasability is longer lasting than the build window counterparts currently in use.

Examples of types of 3D printers that can have an exposure window of the present disclosure include, but are not limited to, Digital Mask Projection stereolithography (e.g., Ember by Autodesk, Phoenix Touch Pro UV DLP SLA), micro-stereolithography printers, and laser based direct-write stereolithography systems (e.g., FormLabs form 1, 1+, and 2, Pegasus Touch Laser SLA, Materialise Mammoth).

A build window can replace the build windows in digital mask projection stereolithography printers (e.g., Ember by Autodesk, Phoenix Touch Pro UV DLP SLA), micro-stereolithography printers, and laser based direct-write stereolithography systems (e.g., FormLabs form 1, 1+, and 2, Pegasus Touch Laser SLA, Materialise Mammoth). A build window can be secured to the modified printers by, for example, chemical adhesives and silicone caulks.

Examples of organic polymers are provided herein. Examples of organic polymers include, but are not limited to, polymethylpentene and derivatives thereof. Organic polymers are commercially available or can be produced using methods known in the art.

An organic polymer exposure window can have various thickness. For example, an organic polymer build window thickness of 0.1 mm to 10 mm, including all 0.1 mm values and ranges therebetween. For example, a build window is 0.5 m×0.5 m.

The following Statements provide examples of apparatuses, methods, and devices of the present disclosure:

Statement 1. A polymer composition comprising: a first polymer component (e.g., a vinyl polymer component of the present disclosure such as, for example, a siloxane polymer comprising a plurality of vinyl groups); a second polymer component of the present disclosure (e.g., a thiol polymer component such as, for example, a siloxane polymer comprising a plurality of thol groups); and a photoinitiator.
Statement 2. A polymer composition according to Statement 1, where the polymer composition comprises a plurality of different first polymer components (e.g., different siloxane polymers comprising a plurality of vinyl groups) and/or a plurality of second polymer components (e.g., different siloxane polymers comprising a plurality of thiol groups).
Statement 3. A polymer composition according to any one of Statements 1 or 2, where the first siloxane polymer and/or second siloxane polymer independently has a molecular weight of 186 g/mol to 175,000 g/mol or 268 g/mol to 175,000 g/mol.
Statement 4. A polymer composition according to any one of the preceding Statements, where the first siloxane polymer and/or second siloxane polymer independently has a molecular weight of 186 g/mol to 50,000 g/mol or 268 g/mol to 50,000 g/mol.
Statement 5. A polymer composition according to any one of the preceding Statements, where one or more of the one or more vinyl polymer components is a branched vinyl polymer component and/or one or more of the one or more thiol polymer components is a branched thiol polymer component.
Statement 6. A polymer composition according to any one of the preceding Statements, further comprising a diluent, non-reactive additive, nanoparticles, or a combination thereof.
Statement 7. A polymer composition according to any one of the preceding Statements, where the absorptive compound is a dye or pigment.
Statement 8. A polymer composition according to any one of the preceding Statements, further comprising a solvent.
Statement 9. A method of making a 3D structure (e.g., a 3D object) comprising: exposing a layer of a polymer composition of the present disclosure (e.g., a polymer composition of any one of Statements 1 to 8) (e.g., a first layer of polymer composition) to electromagnetic radiation such that at least a portion of the first component and second component in the layer react (e.g., polymerize) to form a polymerized portion of the layer; optionally, forming a second layer of a polymer composition of the present disclosure (e.g., a polymer composition of any one of Statements 1 to 8) (e.g., a second layer of polymer composition) disposed on at least a portion of the polymerized portion of the previously formed polymerized portion and exposing the second layer of a polymer composition to electromagnetic radiation such that at least a portion of the first component and second component in the layer react (e.g., polymerize) to form a second polymerized portion of the second layer; and optionally, repeating the aforementioned forming and exposing a desired number of times, where a 3D structure (e.g., 3D object) is formed.
Statement 10. A method according to Statement 9, where the exposing and forming is carried out using a 3D printer.
Statement 11. A method according to any one of Statements 9 or 10, where the exposing and forming is carried out using stereolithography.
Statement 12. A 3D structure (e.g., 3D object) comprising one or more polysiloxane (e.g., a 3D structure (e.g., 3D object) comprising one or more polysiloxane made by a method of the present disclosure such as, for example, a method of any one of Statements 9-11). In various examples, the 3D structure also comprises two or more siloxane polymer chains crosslinked by an alkyl sulfide bond.
Statement 13. A 3D structure (e.g., 3D object) according to Statement 12, where the 3D structure (e.g., 3D object) has a Young's Moduli at 2% strain, E, of 6-300 kPa and/or elongation at break, γᵤₗₜ, (dL/L₀) of 56-427%.
Statement 14. A 3D structure (e.g., 3D object) according to any one of Statements 12 or 13, where the 3D structure (e.g., 3D object) has a Young's Moduli of 6-to 287 kPa and/or an ultimate elongation of 48-427%.
Statement 15. A 3D structure (e.g., 3D object) according to any one of Statements 12-14, where the 3D structure (e.g., 3D object) survives over 100 cycles to 75% of its ultimate elongation.
Statement 16. A 3D structure (e.g., 3D object) according to any one of Statements 12-15, where the 3D object is a soft, robotic or biomedical device.
Statement 17. A 3D structure (e.g., 3D object) according to any one of Statements 12-16, where the 3D object is a fluidic elastomer actuator, antagonistic pair of fluidic elastomer actuators, spring, living hinge, left atrial appendage occluder, or valve.
Statement 18. A 3D printer (e.g., a stereolithographic printer) comprising a build window comprising an organic polymer.
Statement 19. A 3D printer according to Statement 18, wherein the polymer is polymethylpentene.

The following example is presented to illustrate the present disclosure. It is not intended to limiting in any matter.

### Example 1

This example provides a description of examples of polymer compositions of the present disclosure and uses of the polymer compositions.

Described in this example is the rapid fabrication of high-resolution silicone (polydimethylsiloxane) based elastomeric devices via stereolithography. Thiolene click chemistry permits photopolymerization in under 10 seconds and facile tuning of mechanical properties from Young's modulus=6 kPa to 287 kPa, Ultimate elongation=48% to 427%, by controlling the crosslink density and degree of polymerization. From this elastomeric system, we directly fabricate different complaint machines: (i) a living hinge, (ii) a spring and (iii) a pneumatically powered tentacle.

Thiol-ene chemistry, or alkyl hydrothiolation, is the formation of an alkyl sulfide from a thiol and alkene in the presence of a radical initiator or catalyst. The reaction proceeds rapidly and in such a high yield as to be widely regarded as a form of “click-chemistry.” An ideal paradigm for stereolithography, photoinitiated thiol-ene reactions are not inhibited by oxygen, show reduced shrinkage, and exhibit a rapid increase in gel fraction over a small conversion range. The reaction's step-growth mechanism and high conversion limit the polydispersity and enable control of the resulting photopolymer's network density through appropriate selection of the molecular weight and relative stoichiometry of the thiol and alkene bearing species. Comparatively, acrylate and epoxy based resins rely on photoinitiated free radical polymerization which is not readily controlled, often possesses slower reaction rates and lower yields, and requires additional stabilizing species.

In order to determine compatibility with stereolithography and inform the eventual print parameters, we conducted photorheology on the blends. Through the experiment, we measure the viscosity, storage and loss modulus as a function of exposure time (Table 1). As expected with thiol-ene click reactions, we note a rapid gelation as inferred by the sharp crossover in the storage and loss moduli. Prior to exposure, these blends exhibit low viscosities sufficient for even recoating of the build layer during stereolithography. The trends in final G′ and G″ suggest that the larger molecular weight vinyl PDMS not only increases the distance between crosslinks, but also limits the conversion of thiol-enes to alkyl sulfides, likely due to vitrification.

The storage and loss moduli further imply a wide range of mechanical properties in the photocured resins. Through soft lithography, tensile testing coupons were fabricated out of the above blends after being fully exposed to UV light. Mechanical tests reveal a wide range of elastic moduli (6-287 kPa), ultimate stresses (13-129 kPa) and ultimate elongations (48-427%) within this materials paradigm. Increasing the distance between and/or reducing the density of alkyl sulfide crosslinks yields softer, more ductile samples.

Materials. Vinyl terminated polydimethylsiloxanes with varying molecular weights (Mw): 186, 800, 6000, 17200 and 43000 were added to their stoichiometric equivalent quantities of [2-3% (mercaptopropyl)methylsiloxane]-dimethylsiloxane and [4-6% (mercaptopropyl)methylsiloxane]-dimethylsiloxane copolymer in 1:1 ratios. All the siloxanes were procured from Gelest, Inc. To these mixtures Diphenyl (2,4,6-trimethylbenzoyl) phosphine oxide dissolved in toluene (10 mg/100 μL) was added to obtain 1% (w/w) of photoinitiator to polymer. The polymer solutions were then mixed in a planetary mixer (Thinky-ARM 310) for 30 seconds.

Photorheology. A photorheometer coupled (DHR3, TA instruments) with an ultra-violet (UV) light-source (Omnicure Series 1500, Lumen dynamics) and UV filter (wavelength=400-500 nm) with a constant frequency (1 Hz) oscillatory shear mode was used to determine the procure viscosity, cure behavior and the complex moduli of the resins. A parallel plate (diameter=20 mm) geometry was used with a gap size of 1 mm. The power density at the sample was measured to be 9 mW cm⁻² using a Silver Line UV Radiometer (230-410 nm).

Mechanical tests. Resins were poured into dog-bone shaped coupons (width=4 mm, depth=1.5 mm and gauge length=13 mm) and cured with 80 mW cm⁻² UV light (Omnicure Series 1500; Lumen dynamics) for 60 seconds to ensure complete exposure. Uniaxial tensile tests were carried out for each type of resin using a universal testing machine (Zwick/Roell Z1010, Testing systems) at a cross-head movement rate of 10 mm (min=minute(s)) according to ASTM D638 standard. Samples that slipped or fractured as a result of grip stresses were discarded and data was collected until at least seven specimens were successfully tested to failure. Elongation at break and engineering elastic modulus were evaluated for all the resin systems from the stress-strain curves.

A dog-bone specimen made form 2.5%17200 resin formulation was subjected to 100 load-unload cycles at a rate of 6 cycles min⁻¹. The specimen was stretched up to 200% of the unstretched length and unloaded to 0% strain to obtain the stress-strain curves.

3D Printing. Three compliant machines were designed using CATIA V5 and sliced with an Autodesk Print Studio. For example, the photo-exposure was less than 10 seconds per 100 micron layer. Autodesk Ember 3D printer was used to print the different compliant machines. Sudan I was mixed with toluene in the ratio of 0.1 mg mL⁻¹ added to the resins before printing as a UV absorptive species to limit cure depth to the layer height.

SMS-022 = 2-3% (MERCAPTOPROPYL)METHYLSILOXANE]-
DIMETHYLSILOXANE COPOLYMER, 120-180 CST
SMS-042 = [4-6% (MERCAPTOPROPYL)METHYLSILOXANE]-
DIMETHYLSILOXANE COPOLYMER, 120-170 CST

Vinyl Terminated Polydimethylsiloxanes are described herein.

### Example 2

This example provides a description of examples of polymer compositions of the present disclosure and uses of the polymer compositions.

Described is a low-cost build window substrate that enables the rapid fabrication of high resolution (˜50 μm) silicone (polydimethylsiloxane) based elastomeric devices using an open source SLA printer. Our thiol-ene click chemistry permits photopolymerization using low energy (Hₑ<20 mJ cm⁻²) optical wavelengths (405 nm<λ<1 mm) available on many low-cost SLA machines. This chemistry is easily tuned to achieve storage moduli, 6<E<283 kPa at engineering strains, γ=0.02; similarly, a large range of ultimate strains, 0.5<γᵤₗₜ<4 is achievable through appropriate selection of the two primary chemical constituents (mercaptosiloxane, M.S., and vinylsiloxane, V.S.). Using this chemo-mechanical system, we directly fabricated compliant machines, including an antagonistic pair of fluidic elastomer actuators (a primary component in most soft robots). During printing, we retained unreacted pockets of M.S. and V.S. that permit autonomic self-healing, via sunlight, upon puncture of the elastomeric membranes of the soft actuators.

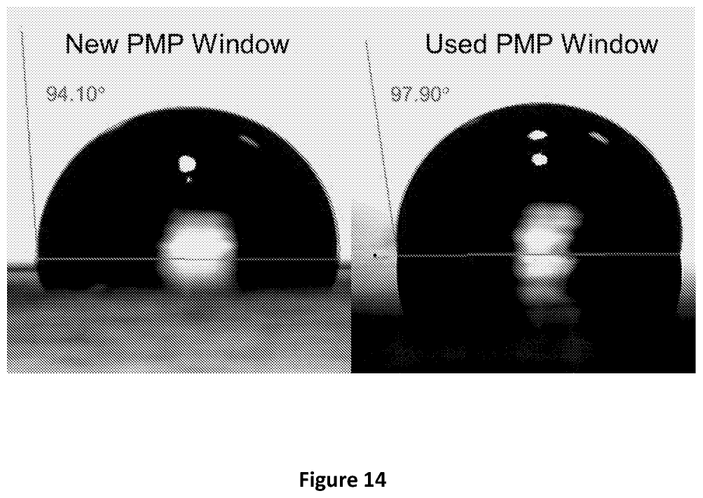

Ember™ by Autodesk, a commercial desktop SLA printer, uses light emitting diodes (λ=405 nm, Eₑ˜22.5 mW·cm⁻²) to project 1280×800 pixels on to a build area of 64×40 mm. Widely available and inexpensive (<$1 for a 75 mm×50 mm×1 mm sheet), we used PMP to replace the conventional PDMS build window in the printer. PMP is stiff, transparent (>90% transmission at 400 nm, >80% transmission at 325 nm), and oxygen permeable (12,000 cm³ mm m⁻² d⁻¹ MPa⁻¹ at 25° C.). A linear, isotactic polymer with a low surface tension (24 mN m⁻¹), PMP is a great release substrate with low separating forces from a variety of materials, including siloxanes. Additionally, PMP's excellent chemical resistance and low swelling in common solvents prevents performance degradation in the build window over long periods. These windows do not change appreciatively in their surface energy, as measured using goniometry (FIG. 14), over 100 s of hours of use.

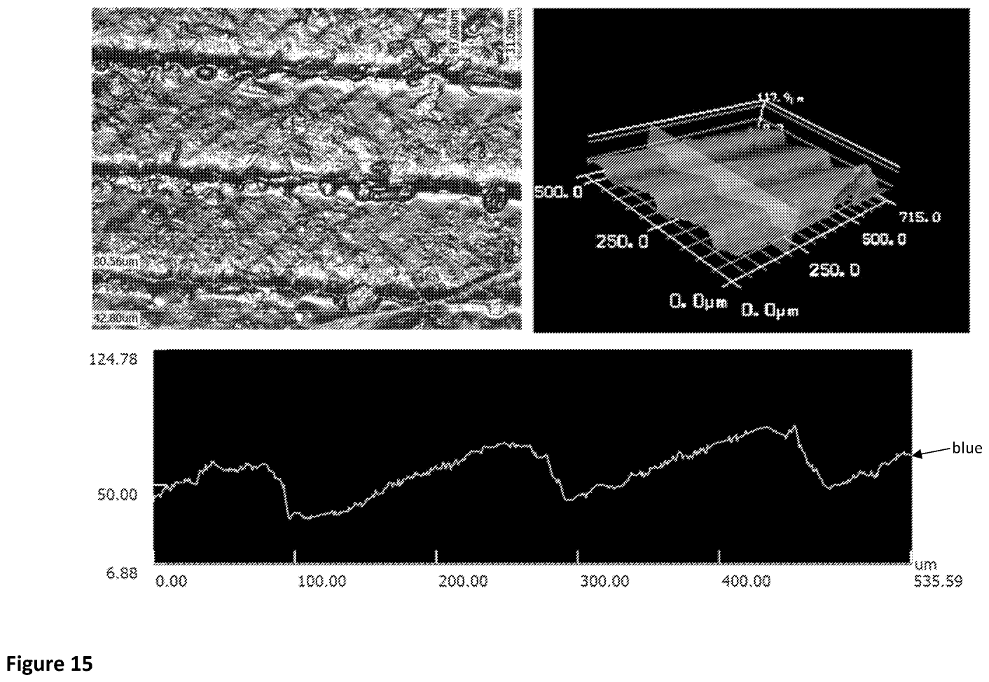

Our resins use a blend of poly-(mercaptopropyl)methylsiloxane-co-dimethylsiloxane (M.S.: M_{w}˜6,000-8,000) and bifunctional vinyl terminated PDMS (V.S.). PDMS, a class of silicones, is a widely used elastomeric material owing to its excellent mechanical properties, chemical inertness, low toxicity, and resistance to thermal degradation. Functional groups, including vinyl and mercaptan, can be added along the polymeric backbone to impart desired chemical reactivity to the PDMS materials platform. We further narrowed the polymer compositions by considering the rheology of the liquid resin and the mechanical properties of the polymerized elastomer: high molecular weight PDMS (Mw>50,000) is too viscous for fast printing and low molecular weight PDMS yields highly crosslinked and brittle elastomers. We control the photopolymerized network structure by selecting the relative density of pendant thiol groups on the M.S. (2-3 mole % and 4-6 mole %) and varying the length of the backbone of the V.S. (Mw˜200, 800, 6000, 17200, 42000) as shown in FIG. 9B. To promote thiol-ene conversion, we maintain a 1:1 thiol to vinyl stoichiometry in our materials system (Table 2). By convention, we refer to our resins by the molar fraction of thiol groups followed by the molecular weight of the vinyl PDMS (e.g. 2.5%17200 is a blend of 2-3% M.S. in V.S. with a molecular weight of 17,200). The addition of a small amount of photoinitiator (diphenyl (2,4,6-trimethylbenzoyl) phosphine oxide [TPO]) and absorptive species (Sudan I) permits high resolution (˜50 μm in plane, FIG. 15) fabrication via SLA from these resins as exemplified by FIGS. 9C-9F.

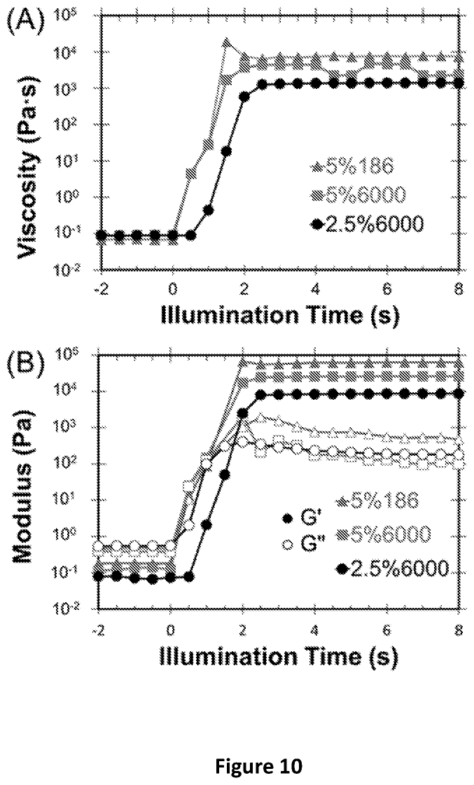

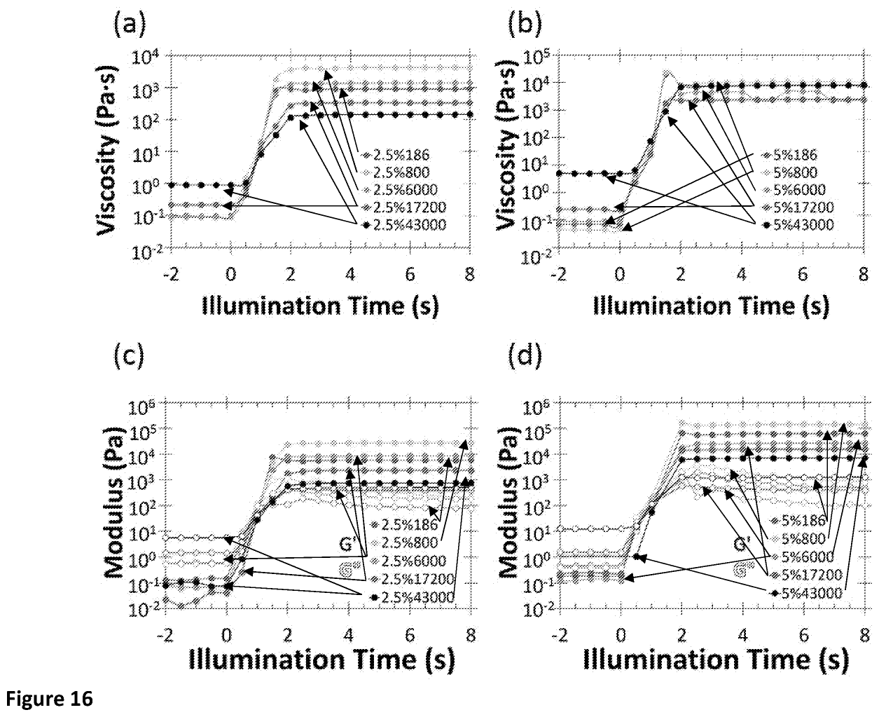

Photopolymerization. Characterization of the photopolymerization helped inform the print parameters (i.e., time of exposure per layer) for each resin. FIG. 10A and FIG. 10B highlight three representative blends that have the flow properties compatible with our SLA system and yield tough silicone elastomers. Prior to exposure, these blends exhibit low apparent viscosities (vₐₚₚ<5 Pa·s) sufficient to evenly recoating the build layer. As expected with thiol-ene click reactions, we note a rapid gelation as inferred by the crossover in the storage, G′, and loss moduli, G″, measured using oscillatory rheology (frequency, ω̅=1 Hz and amplitude, Γ=1% strain). Compared to photopolymerized acrylate based elastomer resins, gelation happens within our chemistry at much lower photodosages (Hₑ˜10 mJ cm⁻²) enabling more rapid build speeds (˜3 cm/hr) (hr=hour(s)) with the light sources used in commercial printers. We report data for all ten blends in FIG. 16 and Table 3. The evolution of storage and loss moduli in all resins plateau immediately after gelation, consistent with click reactions that rapidly reach completion. The different magnitudes of moduli highlight the wide range of possible mechanical properties.

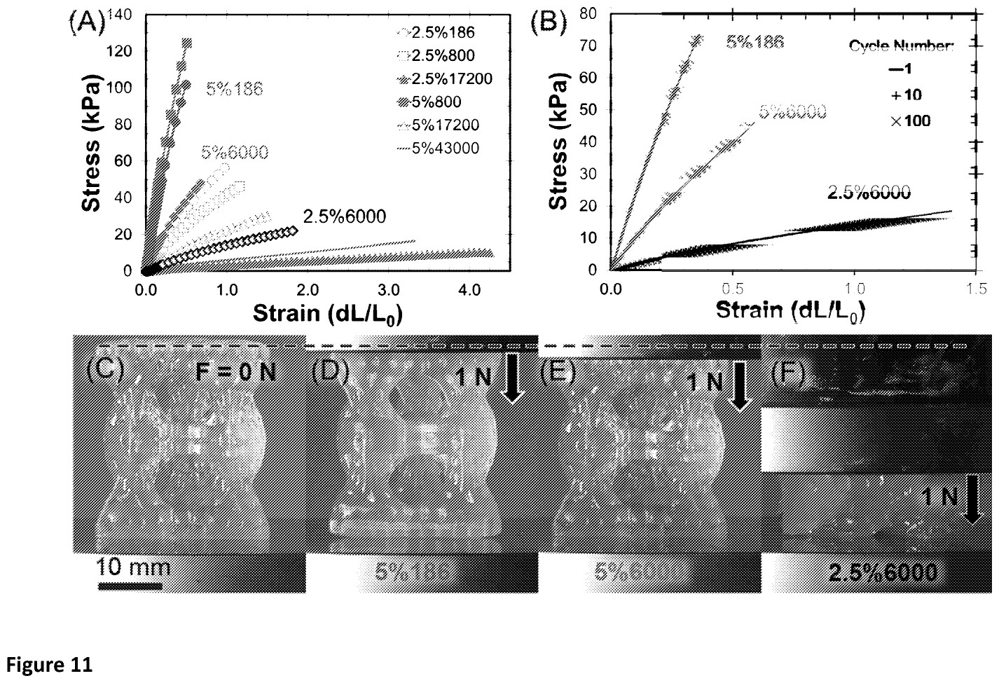

Controllable Mechanical Properties. We investigated the range of mechanical performance by conducting tensile tests of our SLA materials in accordance with ASTM D638. Dogbone test coupons were formed via photopolymerization of the resins in a mold to rapidly iterate through samples. Our mechanical tests reveal a wide range of possible elastic moduli (6<E<287 kPa), ultimate stresses (13<σᵤₗₜ<129 kPa) and ultimate elongations (0.45<γᵤₗₜ<4) within this materials chemistry. Table 4 contains more detailed mechanical data for all blends. FIG. 11A depicts representative tensile data for these blends; for further discussion, we focus on the 5%186, 5%6000, 2.5%6000 resins which demonstrate the wide range of elastic moduli and ultimate elongations possible in this material system. As expected, increasing the distance between and/or reducing the density of alkyl sulfide crosslinks generally yields less stiff, more extensible samples.

In addition, to tunable elastic moduli and ultimate elongations, these SLA materials demonstrate excellent resilience; this property is required for any useful soft machine that will undergo more than a few actuation cycles. Our photopolymerized siloxane systems show great fatigue resistance with little hysteresis at 75% of the achievable ultimate strain (i.e., 0.75*γᵤₗₜ) over at least 100 cycles (FIG. 11B). FIG. 11C shows towers made from Kagome lattices that are extremely difficult to fabricate at these scales with traditional molding techniques. FIGS. 11D-11F show structures made from 5%186, 5%6000 and 2.5%6000 blends, respectively, undergoing different amounts of deformation and buckling in response to a 1N compressive load. The high strain and resilience, coupled with low elastic modulus of these materials are similar to biological tissues and ideal for manufacturing soft robots.

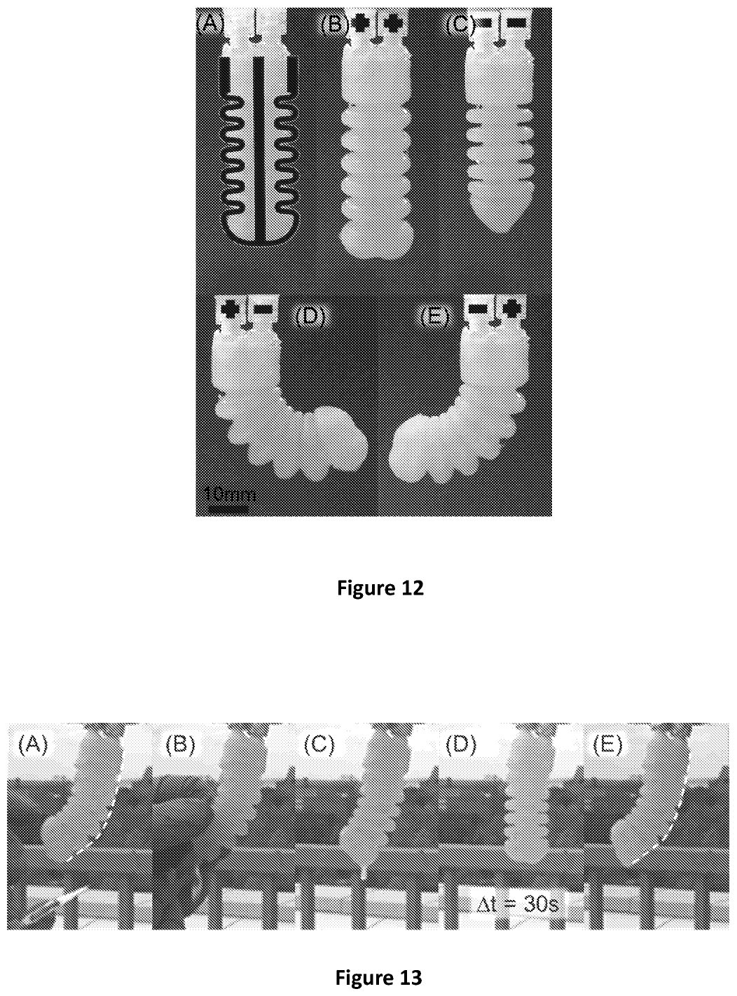

Printing Soft Machines. Fluidic Elastomer Actuators (FEAs) are examples of soft machines that bend when internal channels are pressurized by a fluid and expand. 3D printing has been used to print FEAs with great success; however, the ability to rapidly and directly print whole actuators out of highly resilient and extensible materials has not been demonstrated. FEAs deform continuously about their surface which can enable a variety of locomotive gaits and the manipulation of delicate objects of arbitrary shape. With our 5%6000 blend, we directly printed monolithic, synthetic antagonistic muscles containing a pair of FEAs (FIG. 12A). By pressurizing or evacuating the chambers individually, we demonstrate elongation (FIG. 12B), contraction (FIG. 12C), and bidirectional actuation over >180° (FIG. 12D and FIG. 12E). The inflation of one actuator drives the deflation of the other, resulting in rapid cycle speed ˜250 ms. By inflating and deflating the individual actuators from 0 to 14 kPa alternatively, this device cycled ˜50% of the maximum actuation amplitude over 5,000 times.

Autonomic Self-Healing via Sunlight. FEAs, like balloons, fail when a hole or tear in the body of the actuator prevents the creation of a pressure differential between a fluidic channel and the environment. Our material system permits rapid autonomic self-healing via sunlight induced photopolymerization that recovers actuation capability from such punctures. FIG. 13A shows an antagonistic FEA hydraulically pressurized with unreacted low-viscosity prepolymer resin. We embedded this resin during the printing process by simply polymerizing the structure around the prepolymer, this technique is similar to that for embedding inert hydraulic fluid in polyjet printing. To demonstrate the self-healing efficacy, we pierced the actuator using a scalpel (FIG. 13B) and the actuating fluid escaped as the pressure equilibrated with atmosphere (FIG. 13C). Unlike acrylate resins, which are oxygen-inhibited and require large photodosages to cure, photorheology (FIG. 10) shows that our thiol-ene resins polymerize in the presence of oxygen at low, optical photodosages (Hₑ<20 mJ·cm⁻², λ=400-500 nm). Thus, ambient sunlight (˜15000 cd·m² as measured by Screen Luminance Meter M208) rapidly provides the newly exposed thiol-ene fluid with sufficient spectrum and illumination to polymerize and re-seal the torn actuator within 30 s (s=second(s)) (FIG. 13D). The punctured FEA rapidly healed, allowing re-pressurization and return of the device to its original actuated state as shown in FIG. 13E.

Experimental. Materials. Vinyl terminated polydimethylsiloxanes (V.S.) with varying molecular weights (Mw): 186, 800, 6000, 17200 and 43000 were added to their stoichiometric equivalent quantities of [2-3% (mercaptopropyl)methylsiloxane]-dimethylsiloxane (M.S.) and [4-6% (mercaptopropyl)methylsiloxane]-dimethylsiloxane (M.S.) copolymer in 1:1 ratios as shown in Table 2. All the siloxanes were procured from Gelest, Inc. To these mixtures diphenyl (2,4,6-trimethylbenzoyl) phosphine oxide dissolved in toluene (10 mg/100 μL) was added to obtain 1% (w/w) of photoinitiator to polymer. The polymer solutions were then mixed in a planetary mixer (Thinky-ARM 310) for 30 s.

Photorheology. A photorheometer (DHR3, TA instruments) coupled with a light-source (Omnicure Series 1500, Lumen dynamics) and filter (λ=400-500 nm) with a constant frequency and amplitude (ω̅=1 Hz, Γ=1% strain) oscillatory shear mode was used to determine the cure behavior of the resin: evolution of apparent viscosity and the complex moduli. A parallel plate (diameter=20 mm) geometry was used with a gap size of 1 mm. The power density at the sample was measured to be 9 mW·cm⁻² using a Silver Line UV Radiometer (230-410 nm). Data for each sample was collected in triplicate and with the average reported.

Mechanical Tests. Resins were poured into dog-bone shaped coupons (width=4 mm, depth=1.5 mm and gage length=13 mm) and cured with 80 mW·cm⁻² projected light (Omnicure Series 1500; Lumen dynamics) for 60 s to ensure complete exposure. Uniaxial tensile tests were carried out for each type of resin using a universal testing machine (Zwick/Roell Z1010, Testing systems) at a cross-head movement rate of 10 mm min⁻¹ according to ASTM D638 standard. Strain values were calculated by comparing the change in crosshead displacement to the original gage length. Samples that slipped or fractured as a result of grip stresses were discarded and data was collected until at least seven specimens were successfully tested to failure. Elongation at break, engineering elastic modulus (0.005<γ<0.02), ultimate stress and toughness were evaluated for all the resin systems from the stress-strain curves as reported in Table 4. Cyclic tensile tests were also conducted to understand the fatigue strength of this materials system. Dog-bone specimens were made from the 5%186, 5%6000, and 2.5%6000 resins were subjected to load-unload cycles at a rate of 10% L₀ min⁻¹. The specimens were stretched to ˜75% of their ultimate elongations (36%, 56.25% and 138.75% respectively) and then unloaded to 0% strain for each cycle.

We report the use of thiol-ene photochemistry enabled by a PMP build window for the stereolithography of siloxane elastomers possessing a wide range of mechanical properties. This versatile platform offers the ability to obtain multiple polymer network densities without substantially decreasing the photopolymerization rate or increasing the viscosity beyond SLA limitations. The ability to rapidly fabricate highly extensible silicones with stiffnesses similar to natural, organic tissues in complex 3D architectures offers new technological applications, particularly in the field of soft robotics. To prove this feature, we have demonstrated directly printed, long life cycle antagonistic actuator pairs. We further capitalize on the rapid polymerization of our thiol-ene based formulations at ambient conditions by using our low-viscosity resin as the pressurizing fluid enabling autonomic self-healing in sunlight after rupture in our 3D printed FEAs.

The reported blends are simple stoichiometric equivalents of thiol and vinyl bearing PDMS polymers, but there is potential to increase functionality by modifying the chains to contain an excess of thiol/vinyl groups or even other chemical groups for improved biocompatibility or molecular recognition. Small loading fractions of filler particles (e.g., iron-oxide nanoparticles) might also introduce improved mechanical properties or new optical, electrical or magnetic properties into the printed siloxanes. Additionally, the inexpensive PMP window should enable 3D printed thiol-ene chemistries to be extended to other polymeric back-bones as well as other carbon-carbon double bond groups beyond vinyl, including acrylates.

Resiliency of the PMP Windows. Qualitatively, we have been able to successfully use the same build window in the printer for 100 s of hours, likely due to PMP's low surface tension, low swellability in common solvents, and chemical inertness. As we believe the primary mechanism for its success as a build window is low surface energy to promote delamination, we quantified the change in surface energy over time using goniometry, or contact angle measurements. We first performed these tests on a clean, unused sheet of PMP and then on a build window that has spent 100 s of hours in use in our printers. Using 15 μL drops of water, we measured (VGA Optima Contact Angle) the contact angle of the pristine PMP window to be 98.15±7.38° compared to 95.95±4.57° for the used build window. FIG. 14 shows two representative droplets. The similar wettability of these two surfaces suggests that there is little fouling of the surface, and therefore little change in the surface energetics over this duration of use.”

Printed Resolution. The resolution of a stereolithography resin is highly dependent on the printer used and parameters chosen. The Autodesk Ember printer project 1280×800 pixels on to a build area of 64×40 mm which yields a nominal x and y resolution of ˜50 microns. The photoirradiation dosage, absorptivity of the resin and build stage translations combine to determine the z-axis resolution. For the printed synthetic muscle device shown in FIG. 12, we used 5%6000 resin containing 1 mg mL⁻¹ of Sudan I, with a desired layer height of 100 microns and photoirradiation dosage of wₑ=90 mJ cm⁻². In FIG. 13, the 2.5%186 resin was utilized as the base material (with 1 mg mL⁻¹ Sudan I) and pressurizing fluid. FIG. 15 shows the surface of that monolithic device as measured 3D laser scanning microscope (Keyence VK-X260). Following the build direction (z-axis), the blue line displays a wave with an amplitude of ˜50 μm and a period of roughly 175 μm. The amplitude corresponds to the x and y resolution demonstrating that the 5%6000 resin reaches the nominal resolution of the projected pixel size. We infer z-axis resolution from the period which is well above the build stage translations of 100 microns in between printing steps. While some photopolymerization beyond the desired layer height might improve adhesion between adjacent layers, increasing the resin's absorptivity, or decreasing the photoirradiation could enable greater z-axis resolution.

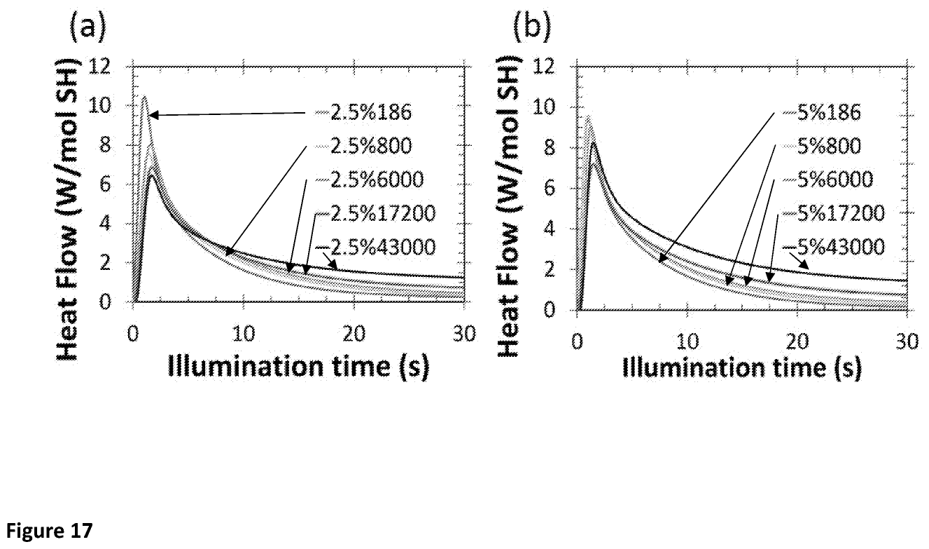

Photo Differential Scanning calorimetry. Differential scanning calorimetry (DSCQ1000, TA instruments) was conducted under exposure to light. The sample and reference pans were left uncovered inside a modified cell with a dual light guide adapter. The cell was aligned such that the reference and sample pans received identical light intensity from the light source (Omnicure Series 1500, Lumen dynamics). As in the photorheology experiments, a filter was used (λ=400-500 nm) and the power density was measured to be Eₑ 10 mW·cm⁻². Samples were equilibrated at 30° C. for 2 minutes prior to exposure for 3 additional minutes with a flow rate of 50 mL min⁻¹. All data was analyzed in TA Quantitative Analysis software. Normalized heat flow curves (mW mol SH⁻¹ vs time), as shown in FIG. 17, were integrated over the exposure using a horizontal sigmoidal baseline and scaled relative to enthalpy of polymerization for thiol-ene reactions (60 kJ mol⁻¹) to obtain the total conversion. For the 2.5%186 and 5%186 resins, the molecular mobility of the shorter V.S. species leads to a slightly faster conversion rate for the first second of polymerization; however, the low molecular weight ultimately limits the final conversion to ˜82% likely due to a reduced probability that the chain is long enough for both vinyl end groups to reach thiol counterparts on other polymers. When the V.S. molecular weight increases, a higher conversion (i.e., 96% conversion for 2.5%6000) becomes obtainable.

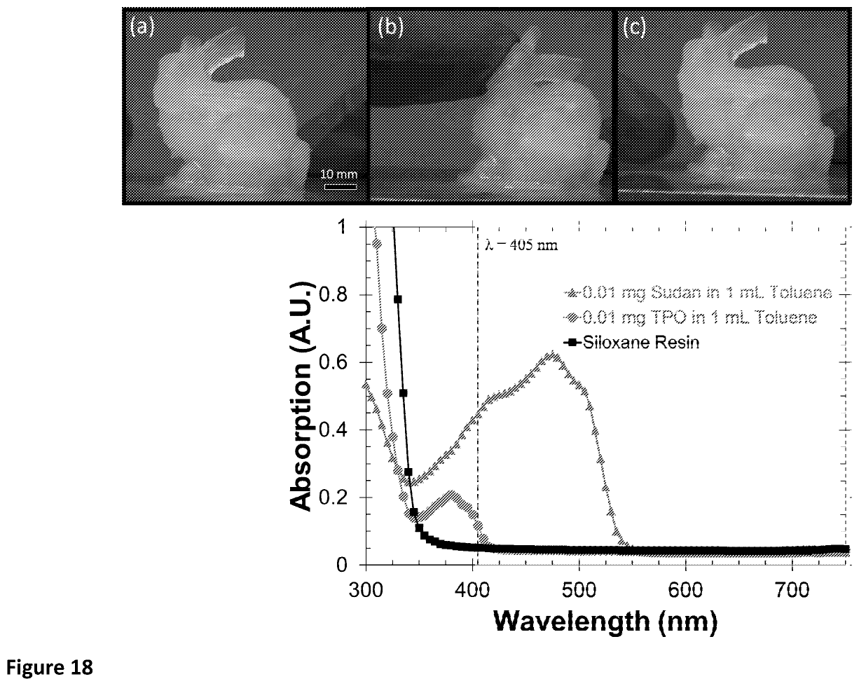

3D Printing. Files for the Kagome Tower, NSF Logo, and Stanford Bunny were obtained freely on the internet. A design file of Touchdown the Bear statue was obtained from artist Brian Caverly and modified using Meshmixer™ software. All other files were created using Solidworks™ software. Using Autodesk Print Studio™, each design was imported, modified, sliced into discrete photopatterns, and converted to a .tar.gz format. The exposure times used varied from 1-5 s depending on the resin composition and layer height. To reduce jamming, the separation slide velocity was set to 2 rpm. Autodesk Ember 3D printer was used to print all objects shown. We mixed Sudan I with toluene in the ratio of 1 mg mL⁻¹ and added this absorptive species to the resins before printing to limit cure depth to the layer height and improve z-axis resolution. FIG. 18 shows that the printed photopolymer blend is optically translucent, but without the addition of Sudan I, the orange absorptive species, z-axis resolution is poor and layer heights are clearly visible.

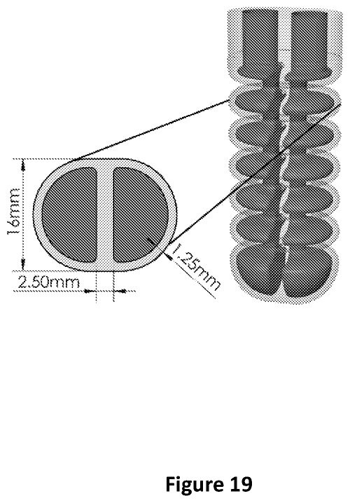

Fluidic Elastomer Actuator. FIG. 19 shows a schematic of the monolithic synthetic muscle device composed of a pair of antagonistic fluidic elastomer actuators. Two three-way solenoid valves (Parker model 912-000001-031) connected each actuation chamber to both the ambient atmosphere and a pressurized air source at ˜14 kPa. Inlet connections to the 3D printed objects were sealed by Sil-Poxy™ (Smooth-On, Inc.) silicone adhesive to prevent leakage. Using an Arduino Uno to control each valve, the antagonistic pair of inflation chambers were alternatively pressurized for 250 ms and then depressurized (via venting to the atmosphere) for 250 ms. With this cycling frequency, the actuator achieved steady-state actuation rapidly, with little deviation from the periodic displacement after the initial 1-2 cycles. This stable periodic actuation lasted for >5,000 inflation cycles with no noticeable decay. Periods of greater than 250 ms similarly achieved bidirectional actuation, but at cycle durations of 100 ms or lower no coherent motion was detected.

TABLE 2
The composition of resins that yield a 1:1 stoichiometry
between thiol and vinyl groups

| M.S. | | | |
|---|---|---|---|
| (MWT: 4000-6000) | | V.S. | |
| Thiol Mole | Amount | Molecular | Amount |
| % | added (g) | Weight | added (g) |
| 2-3% | 970 | 186 | 30 |
| 2-3% | 884 | 500 | 116 |
| 2-3% | 502 | 6000 | 498 |
| 2-3% | 260 | 17600 | 740 |
| 4-6% | 942 | 186 | 58 |
| 4-6% | 794 | 500 | 206 |
| 4-6% | 338 | 6000 | 662 |
| 4-6% | 152 | 17600 | 848 |
| 4-6% | 66 | 43000 | 934 |

TABLE 3
Summarized photocure behavior for all blends

| | | | | | Thiol |
|---|---|---|---|---|---|
| | | ηₜ₌₀ | G′ final | G″_{final} | Conversion |
| Sample Name | t_{cure} (s) | (Pa · s) | (Pa) | (Pa) | (%) |
| 2.5%186 | <1.5 | 0.089 | 5600 | 62 | 81.8 |
| 2.5%800 | <1.5 | 0.088 | 24880 | 72 | 85.8 |
| 2.5%6000 | <1.5 | 0.089 | 8620 | 165 | 96.8 |
| 2.5%17200 | <1.5 | 0.237 | 2310 | 410 | 83.0 |
| 2.5%43000* | <2.0 | 0.896 | 790 | 536 | 76.8 |
| 5%186 | <1.0 | 0.057 | 31610 | 226 | 83.9 |
| 5%800 | <1.0 | 0.044 | 62870 | 580 | 96.1 |
| 5%6000 | <1.0 | 0.066 | 26890 | 91 | 91.8 |
| 5%17200 | <1.5 | 0.247 | 14850 | 42 | 87.7 |
| 5%43000 | <1.5 | 1.884 | 7430 | 1380 | 79.3 |

The time to cure (t_{cure}) is measured by the crossover in storage and loss moduli. The unreacted viscosity ηₜ₌₀ was measured for 20 s prior to photoexposure. G′_{final} and G″_{final} are the stable values measured after 60 s of exposure. Similarly, Thiol conversion was calculated from the total enthalpy of polymerization after 60 s of exposure.

TABLE 4
Complete mechanical data for all blends

| | | Ultimate | Ultimate | |
|---|---|---|---|---|
| | Modulus | Elongation | Stress | |
| Sample | E | γᵤₗₜ | σᵤₗₜ | Toughness |
| Name | (kPa) | (%) | (kPa) | (J m⁻³) |
| 2.5%186 | 83 ± 11 | 110 ± 34 | 64 ± 12 | 26 ± 12 |
| 2.5%800 | 56 ± 5 | 111 ± 22 | 45 ± 8 | 21 ± 7 |
| 2.5%6000 | 19 ± 19 | 185 ± 29 | 23 ± 4 | 16 ± 2 |
| 2.5%17200 | 6 ± 1 | 427 ± 49 | 13 ± 3 | 20 ± 10 |
| 2.5%43000* | * | * | * | * |
| 5%186 | 223 ± 19 | 48 ± 13 | 88 ± 19 | 32 ± 28 |
| 5%800 | 287 ± 24 | 54 ± 13 | 129 ± 20 | 38 ± 16 |
| 5%6000 | 85 ± 17 | 76 ± 15 | 50 ± 12 | 20 ± 8 |
| 5%17200 | 32 ± 6 | 151 ± 8 | 31 ± 7 | 26 ± 8 |
| 5%43000 | 9 ± 1 | 348 ± 32 | 18 ± 4 | 37 ± 11 |

*Sample 2.5%43000 was too soft to manipulate and so no measure mechanical properties were measured.

Although the present disclosure has been described with respect to one or more particular embodiments and/or examples, it will be understood that other embodiments and/or examples of the present disclosure may be made without departing from the scope of the present disclosure.

1) A polymer composition comprising:
a) a first siloxane polymer comprising a plurality of vinyl groups;
b) a second siloxane polymer comprising a plurality of thiol groups; and
c) a photoinitiator,
wherein the second siloxane polymer comprises 0.1-5 mole % thiol groups.

2) The polymer composition of claim 1, wherein the polymer composition comprises a plurality of different first siloxane polymer components and/or a plurality of second siloxane polymer components.

3) The polymer composition of claim 1, wherein the first siloxane polymer and/or second siloxane polymer has a molecular weight of 186 g/mol to 175,000 g/mol.

4) The polymer composition of claim 3, wherein the first siloxane polymer and/or second siloxane polymer has a molecular weight of 186 g/mol to 50,000 g/mol.

5) The polymer composition of claim 1, wherein one or more of the one or more vinyl polymer components is a branched vinyl polymer component and/or one or more of the one or more thiol polymer components is a branched thiol polymer component.

6) The polymer composition of claim 1, further comprising a diluent, non-reactive additive, absorptive compounds, nanoparticles, or a combination thereof.

7) The polymer composition of claim 6, wherein the absorptive compound is a dye or pigment.

8) The polymer composition claim 1, further comprising a solvent.

9) A method of making a 3D structure comprising:
a) exposing a layer of a polymer composition of claim 1 to electromagnetic radiation such that at least a portion of the first siloxane polymer and second siloxane polymer in the layer react to form a polymerized portion of the layer;
b) optionally, forming a second layer of polymer composition of claim 1 disposed on at least a portion of the polymerized portion of the previously formed polymerized portion and exposing the second layer of a polymer composition to electromagnetic radiation such that at least a portion of the first siloxane polymer and second siloxane polymer of the second layer react to form a second polymerized portion of the second layer; and
c) optionally, repeating the forming and exposing from b) a desired number of times,
wherein a 3D structure is formed.

10) The method of claim 9, wherein the exposing and forming is carried out using a 3D printer.

11) The method of claim 9, wherein the exposing and forming is carried out using stereolithography.

12) A 3D object comprising one or more polysiloxane and two or more of the siloxane polymer chains are crosslinked by an alkyl sulfide bond.

13) The 3D object of claim 12, wherein the 3D object has a Young's Moduli at 2% strain, E, of 6-300 kPa and/or elongation at break, γᵤₗₜ, (dL/L₀) of 56-427%.

14) The 3D object of claim 12, wherein the 3D object has a Young's Moduli of 6-287 kPa and an ultimate elongation of 48-427%.

15) The 3D object of claim 12, wherein the 3D object survives over 100 cycles to 75% of its ultimate elongation.

16) The 3D object of claim 12, wherein the 3D object is a soft, robotic or biomedical device.

17) The 3D object of claim 12, wherein the 3D object is a fluidic elastomer actuator, antagonistic pair of fluidic elastomer actuators, spring, living hinge, left atrial appendage occluder, or valve.

18) A 3D printer comprising a build window comprising an organic polymer.

19) The 3D printer of claim 18, wherein the polymer is polymethylpentene.
